(19) United States
(12) Patent Application Publication
(10) Pub. No.: US 2026/0197591 A1
(43) Pub. Date: Jul. 9, 2026

(54) PLANAR-DYNAMIC ACOUSTIC TRANSDUCER

(71) Applicant: Roland JACQUES, Burgwedel-Thoense (DE)

(72) Inventor: Roland JACQUES, Burgwedel-Thoense (DE)

(21) Appl. No.: 18/863,852

(22) PCT Filed: May 11, 2023
(86) PCT No.: PCT/EP2023/062590

§ 371 Date: Nov. 7, 2024

(30) Foreign Application Priority Data
May 11, 2022 (DE) 10 2022 111 851.7

(51) Int. Cl. H04R 13/00; H04R 7/04; H04R 7/18

(52) U.S. Cl. CPC H04R 13/00; H04R 7/04; H04R 7/18; H04R 2400/01

(57) ABSTRACT

A planar-dynamic acoustic transducer having at least one magnet arrangement having a plurality of magnetic poles and having at least one acoustic aperture and having a diaphragm having at least one conductor track, wherein the magnet arrangement has an inner region, which includes the magnetic poles, and an edge region, which surrounds the inner region and connects the elements thereof to one another, wherein the inner region of the magnet arrangement is arranged in a manner offset from the conductor track of the diaphragm perpendicular to the horizontal and in a manner at least overlapping, preferably congruent, with the conductor track of the diaphragm in the horizontal. The planar-dynamic acoustic transducer is characterized in that the edge region of the magnet arrangement furthermore includes at least one mechanical, acoustic and/or electrical function of the planar-dynamic acoustic transducer.

The present invention relates to a planar-dynamic acoustic transducer.

To generate sound, for example in loudspeakers, so-called acoustic transducers are used as sound sources, which convert electrical voltage into acoustic signals. Conversely, a sound transducer can also convert acoustic signals as alternating sound pressures into electrical signals or electrical voltage, which is converted in microphones, for example. This can be done according to different principles.

### 1. DYNAMIC ACOUSTIC TRANSDUCERS

Nowadays, electrodynamic or dynamic loudspeakers, which work according to the electrodynamic principle, are widely used. Accordingly, an electrical conductor is placed in a magnetic field. Either a magnetic field coil or a permanent magnet can be used to generate the magnetic field. If the electrical conductor is now energized, this leads to a mechanical movement of the electrical conductor due to the Lorentz force, which depends on the direction of the current. The mechanical movement of the electrical conductor is transmitted, usually with the help of a diaphragm element, to the air as the surrounding medium, where it causes acoustic waves as acoustic signals. The detection of acoustic waves can be reversed and is used, for example, in microphones.

Dynamic acoustic transducers with a cone-shaped design are widely used, which consist of the magnet system, also known as the magnet arrangement, a voice coil, a shaped diaphragm, a suspension, and a housing or chassis and, depending on how the magnetic field is generated, can be referred to as electrodynamic cone loudspeakers or permanent magnetic cone loudspeakers. In any case, the conical design of the diaphragm and the cylindrical shape of the voice coil lead to a comparatively high structure in the direction of sound emission and thus to a comparatively large installation space. The components of such dynamic acoustic transducers also result in a non-negligible weight. The acoustic waves are generated in small areas or at specific points, which does not correspond to natural acoustic waves. In addition, the tight mechanical tolerances required between the coil and the magnet system, as well as the complex assembly of the above-mentioned and other individual parts, lead to considerable development and manufacturing costs.

Nevertheless, acoustic transducers based on the established dynamic acoustic transducer principle described above dominate in commercial products, although dynamic acoustic transducers have disadvantages in terms of power and sound quality, which can only be mitigated with great effort.

For example, the diaphragm can be designed to be flat; in this design, however, it has an increased tendency to undesirable natural oscillations or modes and must also be mechanically damped and stiffened, which increases the moving mass, the inertia of which impairs the reproduction of high sound frequencies. Simplifying the magnet system, for example by omitting the pole plate or by positioning the voice coil lower in the magnet system, results in a less focused, inhomogeneous magnetic field that is asymmetrical in relation to the diaphragm's rest position, which leads to lower efficiency and increased non-linearities and acoustic distortions. Approaches to generate the drive force radially to the diaphragm axis and redirect it mechanically to the axial direction, see e.g. WO 2011/013223A1 , lead to a considerably more complex design, combined with greatly increased costs for the structural parts and their assembly.

US 2015/256912 A1 shows an example of a dynamic loudspeaker with a flat diaphragm that is integral to a larger structure. A trim part of an automobile interior has an aperture into which a flat loudspeaker diaphragm, consisting of a circumferential elastic surround and a rigid diaphragm panel, is inserted. Bridge-shaped struts are attached to the back of the trim part, which span the diaphragm opening and to which an electromagnetic actuator is attached in the middle, whose voice coil deflects the diaphragm from its resting position to generate sound. Some progress has been made in terms of the overall construction depth and the complexity of the assembly; however, the disadvantages of a flat diaphragm design already mentioned also exist here, and a large number of individual components are still required, which have to be prefabricated separately and then assembled.

### 2. ELECTROSTATIC ACOUSTIC TRANSDUCERS

Another known acoustic transducer principle is electrostatic systems, which consist of one or two flat electrode grids and a flat stretched membrane film positioned between them. With the help of a comparatively high polarization voltage, which is modulated by the useful signal, electrostatic forces are generated between the diaphragm and the electrodes, which deflect the diaphragm and generate acoustic sound.

The objectives of flat design and comparatively simple construction, which are relevant for many applications, have been achieved here. For this reason, the prior art includes applications of this principle for sound reinforcement in the interior of an automobile, e.g. in DE102006045385A1. However, during operation there is a risk that the diaphragm may come into contact with one of the electrodes due to excessive deflection or external air pressure fluctuations and adhere to it electrostatically until the polarization voltage is switched off.

To reduce this risk of interruption, other measures are required, such as additional electrical insulation, multi-layer diaphragm construction, or high mechanical diaphragm tension, which increase the manufacturing costs and impair the acoustic power (reduced efficiency, mass damping of high vibration frequencies, reduced low-frequency reproduction due to high fundamental resonance frequency). There are also disadvantages due to the electrical polarization voltage, which is typically several hundred volts. In the event of a malfunction, this may pose a danger or impairment to persons or technical systems. Furthermore, parasitic electrical effects in the supply lines lead to a significant voltage drop, which depends on the line length and must be compensated for by technical effort, for example by even higher source voltages or complex line constructions. Alternatively, the high-voltage source can be positioned in the immediate vicinity of the acoustic transducer, but this requires additional lines for the supply voltage and additional installation space. In applications such as the interior of a motor vehicle, for example, each of these variants has considerable disadvantages.

### 3. SURFACE TRANSDUCER

A different approach is taken with surface transducers, bending wave transducers, and similar systems. Here, a flat solid body is excited by one or more point actuators to vibrate or bending waves, which in turn lead to sound radiation.

The disadvantage here is that considerable design and signal processing measures are required to achieve sufficiently controlled acoustic behavior in the vibrating surface. There must be no excessive or non-linear resonance at the frequencies corresponding to the surface's own modes, and the power of the acoustic radiation should fall off as little as possible between these frequencies. Said requirement is technically challenging due to the comparatively large oscillating mass, particularly at high frequencies.

A particularly efficient use of space is achieved as soon as existing surfaces, e.g. from screens, furniture, or vehicle interior trim or body parts, are used. Examples of this are U.S. Pat. No. 6,181,797 B 1 (automobiles) and U.S. Pat. No. 6,332,029 B1 (screens and other applications). However, this multiple use requires functional and design compromises. The shaping, assembly, thickness, and material composition as well as the positioning of the actuators can usually only be optimized for acoustic power to a very limited extent, and the required vibrations can be detrimental to the original functions or the longevity of the flat structural part. In addition, there are long-term signs of ageing of the structural part, which can significantly deteriorate its vibration properties, e.g. changes in elasticity (embrittlement or softening), mechanical tolerances, or the coupling or connection with neighboring components.

### 4. PLANAR DYNAMIC PRINCIPLE

Planar-dynamic acoustic transducers have also been known for some time, which consist substantially of a planar magnetic arrangement or two planar magnetic arrangements, parallel to or between which a diaphragm with conductor tracks applied to it is positioned. The electrically conductive conductor tracks interact with the field of the multi-pole magnet arrangements when current flows through and generate a force acting normally on the diaphragm plane, causing the diaphragm to deflect elastically and generate an air displacement and thus sound pressure.

This means that planar-dynamic acoustic transducers can usually be constructed thinner than dynamic acoustic transducers with a conical design, although planar-dynamic acoustic transducers are longer and wider in the diaphragm plane. However, the increased radiating surface of planar-dynamic acoustic transducers requires less excursion and is therefore subject to less distortion. Furthermore, a comparatively large-area acoustic radiation is achieved, which corresponds better to the conditions in natural acoustic fields than the more specific acoustic source with point contact represented by a dynamic acoustic transducer with a conical design. Another advantage of planar-dynamic acoustic transducers is the generally significantly lower mass of the membrane film and the planar conductor tracks, which can result in improved dispersion behavior of pulses, transients and high frequency components.

In other words, planar-dynamic acoustic transducers, which are also referred to as ortho-dynamic or iso-dynamic transducers, have a planar diaphragm on which electrical conductor tracks are located and which is parallel to and at a short distance from a magnet arrangement. The magnet arrangement generates a multipole magnetic field in such a manner that the field lines in the region of the conductor tracks run tangentially to the diaphragm and perpendicular to the conductor tracks. When current flows in said conductor tracks, a force acting normal to the diaphragm is created, causing it to deflect and generate sound. Such an acoustic transducer can be used in loudspeakers and headphones as an acoustic transducer, and in reverse mode, i.e. by deflecting the diaphragm through acoustic sound and thereby inducing an alternating current, it can also be used as a microphone.

Planar-dynamic acoustic transducers usually consist of a plurality of structural parts, including magnetic rods or rings, brackets, stiffeners, adhesives, and similar, which have to be manufactured and assembled individually. Conventional magnet arrangements of planar-dynamic acoustic transducers use simple bar magnets, for example, which have a north pole on one long side and a south pole on the opposite long side. These already premagnetized rods must be placed in a bracket with alternating alignment and glued to it, which involves assembly work and the use of materials. Other structural parts, such as spacer rings, contacting parts, and similar, are usually added.

In each case, the aforementioned assemblies are then assembled to form the planar-dynamic acoustic transducer, which in turn is mounted in the end product, such as the loudspeaker, headphones, microphone, and similar. In addition to brackets, frames, screw connections, and similar, acoustically effective structural parts, such as fabrics, resonators, foams, or so-called acoustic metamaterials, are also used.

### 5. PLANAR DYNAMIC PRINCIPLE WITH SEPARATE MAGNETS

U.S. Pat. No. 5,901,235 A describes a planar magnetic transducer with diaphragms containing electrical conductors mounted in frames such that spaced magnets are arranged on opposite sides of the central sound-generating surface regions of the diaphragms by means of metallic support grids.

US 2015 110 339 A1 describes a planar multi-diaphragm electroacoustic transducer with a plurality of diaphragms arranged in one or more diaphragm modules. Each diaphragm module comprises at least one diaphragm, each of which is held taut by a frame.

US 2018/0084346 A1 describes a planar speaker unit with an enclosure, a first set of magnets, and a diaphragm. The enclosure has a receiving room and a bottom wall. The first set of magnets is arranged on the floor wall and is located in the receiving room. The diaphragm is arranged in the receiving room and is located above the first set of magnets. The diaphragm comprises a substrate and a planar coil. The planar coil is mounted flat on the substrate.

U.S. Pat. No. 10,003,876 B2 describes a planar magnetic headphone consisting of a single layer of parallel elongated magnets spaced apart and resting on a magnetic holder matrix. The holding matrix can be made of plastics or a metallic permeability plate, wherein the magnets are located on the inside (towards the ear) of the plate. On the inside of the magnets there is a damping matrix made of plastics, which carries a first continuous disk-shaped damping diaphragm. A serpentine conductor track is attached to a thin diaphragm located outside the magnets, which energizes the magnets and moves the diaphragm to generate sound according to the current in the conductor track. Further outside the conductor track and attached to an outer hard plastic cover is a second continuous disk-shaped damping diaphragm.

DE 10 2017 102 159 A1 describes a planar-dynamic acoustic transducer, which often consists of two opposing magnet arrangements, each with a plurality of magnetic rods arranged in parallel, and a diaphragm with a flat coil in between. The plane of the magnet arrangement is parallel to the diaphragm plane. The repulsive forces between the two magnet arrangements and the connecting elements for fixing the arrangement can cause stresses, torsion, deflection, or similar. Conventionally, the diaphragm film is either fixed directly to the magnetic holder or to a separate structural part, e.g. a carrier frame. The mechanical stresses are transferred to the very thin, pre-stressed diaphragm film and impair its flatness and/or the homogeneity of the mechanical stress. In the present planar dynamic transducer with a first planar magnet arrangement, a fastening element and a diaphragm with conductor tracks and at least one diaphragm support frame, the diaphragm support frame is clamped between the magnet arrangement and the fastening element. An elastic decoupling element is located between the diaphragm carrier frame and the first magnet arrangement and/or between the diaphragm carrier frame and the fastening element.

US 2014/0270326 A1 describes a planar magnetic transducer having a frame and a primary magnet row structure of elongated magnets adjacent to and having an air gap from a first surface side of a movable portion of a thin film or thin structure diaphragm with conductor tracks incorporated into the diaphragm. An additional pair of magnetic sources attached to the frame outside the vibratable region of the diaphragm and mounted above the plane of the opposite, second surface side of the diaphragm to amplify the magnetic energy near the second surface side of the foil diaphragm without any rows of magnets directly in front of the second surface side of the vibratable region of the diaphragm between the additional pair of magnetic sources.

As is known from the relevant material data sheets, the magnetic rods typically used, which are made of neodymium (Nd2Fe14B) (this also applies analogously to other designs, such as rings, etc.), require a very high magnetic field strength H of e.g. 2,400 kA/m due to their high coercive field strength, which goes hand in hand with the desired high energy density, in order to be completely magnetized or polarized up to the saturation range. Such field strengths, even if they are only required in pulses, can only be generated by magnetizing devices (electromagnets in the form of solenoids or otherwise shaped coils) whose dimensions significantly exceed those of the structural part to be magnetized.

Together with the requirement that the magnetic rods must be arranged with alternating polarity, this means that the magnetic rods must be individually magnetized before assembly. During assembly or positioning in an assembly device or an injection molding tool, the magnetic rods are therefore in a magnetized state and thus develop considerable mechanical repulsive or attractive forces, depending on their relative position to each other and to other ferromagnetic structural parts or tools. For example, the force between two magnetic rods made of the common neodymium alloy “N45”, each measuring 2×4×40 mm, is around 40 N on contact and as little as 10 N at a distance of 2 mm.

In order to take this problem partially into account, US 2005/036646 A1 in FIGS. 42 to 44 shows carrier grids with pins or webs protruding perpendicular to the surface, which hinder lateral movement of the magnetic bars due to the repulsion/attraction forces until the adhesive between the magnetic bars and carrier grid has hardened. In particular, there is a constant force of attraction between planar adjacent, parallel magnetic rods with usually alternating polarity, which must be countered in a suitable manner in order to maintain the desired position and spacing between the magnetic rods. However, as additional magnetic bars are added, they exert forces in a different direction that lift the already positioned bars out of this position or twist them (especially if they are resting on non-magnetic material), unless further measures are taken to temporarily fix them in place.

Another problem is the high brittleness or fragility and the very low elasticity of the magnetic rods due to their powder metallurgical manufacturing method. In the event of an uncontrolled collision or otherwise increased force, this often leads to the magnetic rods breaking and splintering, resulting in material waste and danger to persons and apparatus due to flying splinters or crushing. All the properties of the magnetic rods mentioned so far lead to considerable effort in their storage, removal, manipulation, positioning, and temporary fixing until they are finally fixed in their final position, e.g. by clamping or bonding to a carrier element or by plastics overmolding.

Planar-dynamic acoustic transducers according to the state of the art involve additional effort and costs due to the multi-part structure consisting of the carrier system for the magnetic rods, carrier system for the diaphragm film, electrical connections, mechanical interfaces to the housing and other structural parts, protective grid, and baffle or housing.

In WO 03/094571A2 , FIGS. 15-27 to 15-29 and the associated description describe an assembly method in which magnetic rods (15-2704, 15-2904) are positioned in the cavity of an injection mold and fixed there by spring pins (15-2900). How these potentially conflicting steps (positioning, fixing, and subsequent closing of the injection mold) are to be carried out is not explained in detail, despite detailed manufacturing process descriptions elsewhere in WO 03/094571A2 . The need for fixation described here once again shows the problem of magnetic attraction forces described above.

In addition, the cavity wall, which is not described in more detail, could be made of ferromagnetic steel; the resulting attractive forces to the wall would then support the temporary fixation of the magnetic rods, but at the same time, pose the risk of material breakage of the magnetic rods during insertion due to too rapid impact on the cavity wall and also make demolding of the assembly much more difficult, wherein the magnetic rods could be broken out of the plastics if they adhere more strongly (magnetically) to the cavity wall or the ejectors than to the adjacent plastics parts.

In the next step, the magnetic rods of WO 03/094571 A2 are joined together to form an assembly by overmolding them with suitable plastics, which permanently fixes their relative position and at the same time, forms an acoustically open carrier grid (15-2600). The magnetic rods also have internal slots (15-2800), which are filled by the plasticized plastics to achieve a positive fit. This again indicates that the material bond between the plastics and the usually smooth (e.g. nickel-plated) and non-tempered surface of the magnetic rods is insufficient, comparable to the desired low adhesion between the plastics and the cavity wall.

The additional mechanical processing step required to create the slots in the brittle magnetic rods is generally very cost-intensive, partly due to the slow processing speed required and/or the increased reject rate. The fact that the cost of mechanical processing of the magnetic rods is highly relevant is also shown by the statement in WO 03/094571A2 , according to which the alignment of the magnetic rods on the cavity wall shown in FIGS. 15-29 is advantageous in order to be able to compensate for larger thickness tolerances, which can arise in order to save costs when manufacturing the magnetic rods.

### 6. PLANAR DYNAMIC PRINCIPLE WITH MAGNETIC DISK

Planar-dynamic acoustic transducers that use a grid or a perforated disk made of continuous hard magnetic material are known for the purpose of simplifying the design and the required manufacturing processes. Although this results in investment costs for a casting tool, it also simplifies assembly, as there is only a single, usually not yet magnetized and therefore easy-to-handle magnetic structural part. The relative and absolute positioning of the magnetic poles is usually reproducibly ensured in the subsequent magnetization step.

In the state of the art, however, this grid only has magnetic functions and therefore always requires a separate carrier that provides the mechanical coupling to the other structural parts.

JP 2008 113365 A shows such an acoustic transducer with a perforated magnetic disk (22a, 22b) held by carrier grids (24a, 24b). The acoustic transducer here consists of seven structural parts, plus components for electrical and mechanical contacting.

In U.S. Pat. No. 3,674,946 A, a planar-dynamic acoustic transducer is described which uses an elastic, flat prefabricated and multipole magnetized magnetic material (“Plastiform”, e.g. type 1037), which is perforated and cut to size by punching and similar methods. This is barium ferrite bound in rubber with a low energy product of only around 1.1 MGOe. This comparatively weak magnetic material was chosen because it is very easy to process, mount, and adapt to the shape of a non-flat carrier grid, e.g. through magnetic attraction between the magnetic material and the carrier grid. However, the magnetic field thus provided to drive the acoustic transducer is considerably weaker than that of other materials available at the time of filing U.S. Pat. No. 3,674,946 A, and again considerably weaker than that of today's neodymium magnets, which have an energy product of up to 52 MGOe. Due to the high elasticity of the magnetic material, the use of supporting structures and other assembly components is essential.

In a later application by the same inventor (U.S. Pat. No. 4,471,173 A), in addition to the above-mentioned elastic magnetic material, magnetically stronger materials made of rare earths, such as samarium-cobalt, are mentioned, as well as the production of a perforated magnetic disk by unspecified shaping (“molded to the shape illustrated”) or punching (“die cut”). This magnetic disk is an alternative to the single magnetic strips used in the other embodiments of U.S. Pat. No. 4,471,173 A, and thus also requires a separate carrier grid and other discrete structural parts.

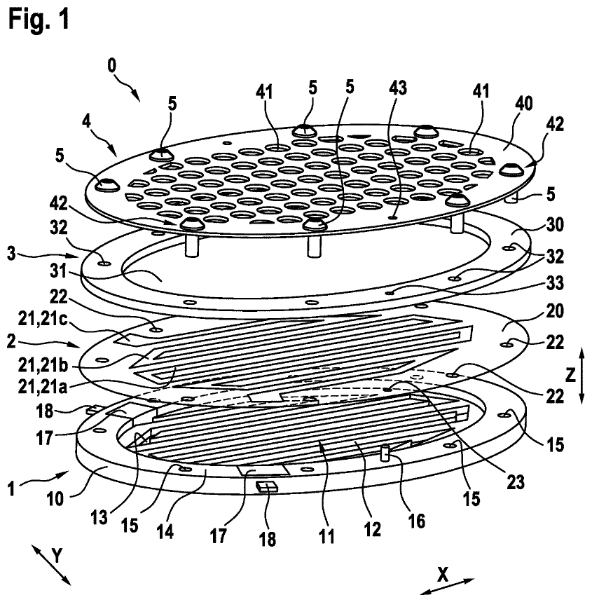

A further variation of an acoustically opened magnetic disk is described in U.S. Pat. No. 10,455,343B2 . The magnetic disk 14 shown there is manufactured in one piece, has exclusively magnetic functionality and is supplemented by a carrier grid 16, a diaphragm carrier ring 12 and other structural parts. Although the magnetic disk 14 can be made of “any ferromagnetic material”, the specification of a required or preferred energy product of the material between 34 and 45 MGOe restricts the choice of material to anisotropic, fully metallic rare earth magnets, in particular sintered neodymium magnets (Nd2Fe14B), which are commercially available in material grades with energy products between 30 and 52 MGOe. The low geometric complexity of the magnetic disk, which allows it to be produced by mechanical processing of sintered neodymium material, and the homogeneous surface-normal magnetization shown in FIG. 1A and FIG. 4B also point to this anisotropic material. The alternative magnetic materials ferrite, AlNICo, plastic bonded neodymium (usually isotropic), and sintered samarium cobalt only achieve maximum values of 5, 9, 12, or 33 MGOe and are therefore not very suitable for acoustic transducers according to U.S. Pat. No. 10,455,343B2 .

U.S. Pat. No. 3,898,598 A describes a dynamic electroacoustic transducer with two slotted disks of permanent magnets spaced parallel to one another to produce a plurality of aligned magnetic fields of alternating polarity in a gap between them. A main diaphragm with a flat coil is kept flat by two auxiliary diaphragms sandwiching it and arranged parallel to the disks in the gap, wherein the magnetic fields intersect the different parts of the coil perpendicularly. Two ring-shaped elastic holders clamp the circumferential edges of the main and auxiliary diaphragms between them to give the main diaphragm the required rigidity. Alternatively, a clamping ring can provide the necessary rigidity to the main diaphragm mounted on the ring-shaped elastic holder.

JP 2010-268045 A relates to the problem of providing a thin acoustic electromechanical transducer which can be assembled more easily than before and has an improved design. For this purpose, a planar loudspeaker is proposed, which is used as a thin acoustic electromechanical transducer. It contains a pair of covers as a housing, and four pins and similar are provided in the housing. The pins are held by fitting both ends into the fitting holes provided in the permanent magnet plates, function as a positioning tool for positioning a vibrating diaphragm and corresponding buffer elements when assembling the planar speaker, and function as a displacement control means for controlling a displacement direction of the vibrating diaphragm after assembly. In addition, the pin is built into the housing, which maintains the design, including the flatness of the housing.

However, the disadvantage remains that such planar-dynamic acoustic transducers still consist of additional structural parts, such as contact clamps, diaphragm rings, spacer rings, screw connections, and the like, which cause corresponding manufacturing effort, tolerance chains, and costs.

For example, DE 10 2017 122 660 A1 describes a planar-dynamic acoustic transducer that contains a magnet plate with elongated air gaps that lie transverse to the conductor. The magnet plate is magnetized on one side with multiple poles so that it contains at least one north pole and one south pole on both sides along each air gap on the side facing the diaphragm and the conductor. This generates the strongest deflection force on the diaphragm directly below the magnetic rods, where the acoustic damping is also strongest. The width of the air gaps in the magnet plate can also be freely selected because it does not depend on the width or spacing of the conductor tracks.

Nevertheless, the usually numerous individual parts and assembly steps of planar-dynamic acoustic transducers lead to a corresponding manufacturing and assembly effort, a variety of materials that is detrimental to reparability and recycling, including the frequent use of adhesives, as well as quality problems due to tolerance chains of the individual components that build on one another. This results in considerable material and labor costs in the manufacture of this type of transducer, which are an obstacle to rational production in large quantities and low unit costs.

One object of the present invention is to provide a planar-dynamic acoustic transducer of the type described above, the manufacture and in particular assembly of which can be simplified. Additionally or alternatively, the acoustic and/or electrical properties should be improved. This should be as simple, cost-effective, space-saving, and/or weight-saving as possible. At the very least, the aim is to provide an alternative to known planar-dynamic acoustic transducers.

According to the invention, the object is achieved by a planar-dynamic acoustic transducer, by a magnet arrangement, by a receiver, by a microphone, and by a loudspeaker with the features of the independent claims. Advantageous further developments are described in the subclaims.

Thus, the present invention relates to a planar-dynamic acoustic transducer having at least one magnet arrangement having a plurality of magnetic poles and having at least one acoustic aperture and having a diaphragm having at least one conductor track, wherein the magnet arrangement has an inner region, which includes the magnetic poles, and an edge region, which surrounds the inner region and connects the elements thereof to one another, wherein the inner region of the magnet arrangement is arranged in a manner offset from the conductor track of the diaphragm perpendicular to the horizontal and in a manner at least overlapping with the conductor track of the diaphragm in the horizontal. Planar-dynamic acoustic transducers of this type are known, for example, from U.S. Pat. No. 3,674,946 A, as described at the beginning.

The planar-dynamic acoustic transducer according to the invention is characterized in that the edge region of the magnet arrangement furthermore includes at least one mechanical, acoustic and/or electrical function of the planar-dynamic acoustic transducer. A mechanical function can be understood to mean a mechanical connection and, in particular, a bracket or mounting of the edge region of the magnet arrangement with, in particular, the diaphragm, which can be direct or indirect. A mechanical function can also be a spacing or a contact or a non-spacing perpendicular to the horizontal between the edge region of the magnet arrangement and the diaphragm. An acoustic function can be understood as influencing the acoustic sound generation or sound detection. An electrical function can be understood to mean electrical contacting, in particular of the conductor track of the diaphragm. Further mechanical, acoustic and/or electrical functions of the planar-dynamic acoustic transducer, which are made possible by the edge region of the magnet arrangement, are not excluded by this.

In any case, the mechanical, acoustic and/or electrical properties of the planar-dynamic acoustic transducer can be improved or enhanced thereby, individually or in combination with each other, which can improve the quality of the planar-dynamic acoustic transducer and a corresponding product such as, for example, an earphone, in particular a headphone, a microphone, a loudspeaker, and the like accordingly. Additionally or alternatively, the manufacturing and in particular the assembly effort can be reduced by taking over more functions from one structural part in the form of the magnet arrangement or its edge region or the same functions from fewer structural parts, thereby saving additional structural parts that would have to be manufactured and assembled. In addition or alternatively, certain design options, such as the electrical contacting of a filigree conductor track of the diaphragm by means of the magnet arrangement, as will be described in more detail below, can be made possible in the first place.

In any case, the edge region of the magnet arrangement can serve not only to connect or mechanically hold together the inner region or the elements thereof, such as its magnetic poles, as previously known, but the edge region of the magnet arrangement can be sufficiently large according to the invention, in particular in the radial direction or in the horizontal, in order to allow further mechanical, acoustic and/or electrical functions and properties as described above. The edge region of the magnet arrangement can be specifically designed in such a manner that the corresponding function is possible and, in particular, can be carried out as effectively as possible.

Preferably arranging the inner region of the magnet arrangement perpendicular to the horizontal to the conductor track of the diaphragm and in the horizontal congruent to the conductor track of the diaphragm can increase the efficiency of the interaction between the magnetic poles of the magnet arrangement and the conductor track of the diaphragm. In particular, the acoustic aperture of the magnet arrangement can run congruently with the conductor track of the diaphragm.

According to one aspect of the invention, the inner region of the magnet arrangement and the edge region of the magnet arrangement are formed in one piece by a magnet body and at least the inner region of the magnet arrangement includes a hard magnetic material, preferably consisting of this. A hard magnetic material is a permanently magnetic material, which therefore has a constant magnetic field and maintains this permanently. Alloys made of iron, cobalt, nickel, or certain ferrites, or even rare earths can be used to form the hard magnetic inner region of the magnet body and thus the magnetic poles of the magnet arrangement.

In other words, according to the invention, it is possible to dispense with additional magnetic elements as separate structural parts, which are previously applied to a grid or similar in order to form a previously known magnet arrangement together with the grid. Rather, according to the invention, the magnet arrangement or its magnet body can be designed both as a mechanically stable element, in particular with an edge region with additional mechanical, acoustic and/or electrical functions as described above, and as a permanent magnetic element in order to combine these properties and thus avoid at least two structural parts at this point of the planar-dynamic acoustic transducer. This can simplify installation accordingly. This can also save weight and/or installation space, particularly in the direction perpendicular to the horizontal.

This can be implemented by at least the inner region of the magnet arrangement having a hard magnetic material to a sufficient degree to achieve the desired interaction with the conductor track and additionally having an additional, preferably non-magnetic, material to complete the magnet arrangement or its inner region and to form the edge region of the magnet arrangement. This may keep the manufacturing costs of the magnet arrangement low if the hard magnetic material is more expensive than the additional material. Alternatively, however, the magnet arrangement or its magnet body can consist entirely of the hard magnetic material, at least in the inner region, which can simplify manufacture and, if necessary, make it more cost-effective. This can preferably also apply to the edge region.

In any case, the magnet arrangement can be formed in one piece, i.e. integrally or monolithically, which can be done by milling, compression molding, or stamping, but also by primary forming, such as by injection molding, by die casting, by metal powder injection molding, by 3D printing, and similar. This can also make production more cost-effective, especially if only one material is used. However, the one-piece production can also be carried out using at least two different materials in a two-component process, for example by injection molding, so that at least two different materials can be used in combination with each other, as mentioned above. For example, the inner region may have or consist partly or completely of a hard magnetic material, while the edge region may consist of a non-magnetic material, which can save hard magnetic material and thus keep the manufacturing costs of the magnet arrangement low.

It may be particularly preferable to make at least the inner region of the magnet arrangement and particularly precisely or only the inner region of the magnet arrangement hard-magnetic and preferably to use hard-magnetic particles, for example of neodymium-iron-boron, which are embedded in a plastics material, such as polyamide, in particular polyamide 6 or 12. Arranging or concentrating the hard magnetic particles precisely or only in the inner region of the magnet arrangement, for example by means of a two-component injection molding method, can allow the use of such hard magnetic particles exactly where the magnetic field is required in order to keep the amount of hard magnetic material and thus the costs as low as possible or to minimize them. The edge region of the magnet arrangement can then in particular be free of the hard magnetic material in order to save the costs of the hard magnetic material there.

According to a further aspect of the invention, the edge region of the magnet arrangement is formed from a different material than the inner region of the magnet arrangement, preferably from a material with a lower specific weight and/or from a material with a lower or no magnetization and/or from an elastic material. This allows the relevant aspects described above and below to be implemented in concrete terms.

According to a further aspect of the invention, the inner region of the magnet arrangement was formed from a first material in a first process step and the edge region of the magnet arrangement was formed from a second, different material in a second method step. This can be done, for example, as a two-component injection molding method (2K injection molding). The designations of the first and second material are not to be understood in the order of use.

For example, in the first partial step of an overall injection molding process, a structural grid is formed from the non-magnetic or weakly magnetic material component, which corresponds to the expected mechanical loads due to its shape and material properties, such as added short glass or carbon fibers, and has the desired acoustic properties, such as transparency or acoustic resistance.

Once the grid has solidified sufficiently, a partial element of the injection mold is moved in the second partial step so that a new cavity is created in the inner region, which largely corresponds to the grid structure in the horizontal plane and is located on the side of the previously produced grid facing the diaphragm. This new cavity can now be filled with the magnetic material component so that it forms a comparatively thin layer on the previously produced grid and bonds with it by plasticizing its surface.

In this manner, the thickness and thus also the amount of magnetic material component required is reduced to the minimum necessary for magnetic field generation. Since the strength of the magnetizing field decreases exponentially with the distance to the flat magnetizing device in the case of one-sided multipole magnetization, for example, a material thickness of 30% of the magnetic pole spacing is sufficient for this. With a pole distance (between the center lines of adjacent north and south pole strips) of 5 mm, the thickness of the magnetic material component can therefore be 1.5 mm. The edge region and other associated elements (such as walls to form acoustic channels or a speaker housing), which must meet lower mechanical requirements and which are produced as part of the same overall injection molding process, can be produced together with the structural grid in the first partial step from the same non-magnetic or weakly magnetic material component, or they can be produced in a third partial step from a third material component consisting, for example, only of the polymer matrix without admixtures.

In a third or fourth partial step, after displacement of individual tool elements, a partial region made of an elastic material can be added, for example, a circumferential sealing ring or elements for vibration decoupling, wherein an interlocking connection between the elastic material and the adjacent, already produced partial region is achieved by suitable material selection or material pairing and suitable process parameters.

If possible surrounding or adjacent structural parts, such as enclosure parts or linings, were not produced in one of the partial steps shown above, they can also consist of fiber composites, pressed fiber material, foamed plastic or metal, or similar materials, which are inserted into a corresponding tool cavity and are completely or partially penetrated by the molten mass introduced in another partial step, or bond with it in the boundary region by superficial plasticization.

The selection and sequence of the partial steps described can be adapted to the specific design, material selection, and other requirements without deviating from the basic idea of the invention.

All of the previously described shapes of the magnet grid according to the invention can also be produced using other manufacturing methods, in particular also using additive manufacturing methods, such as 3D printing, laser sintering, stereolithography, etc., or using powder metallurgy methods, such as laser melting, metal powder injection molding, etc., without deviating from the basic idea of the invention. Other structural parts, such as a rear housing wall (which forms a hollow body and therefore cannot be produced as a whole in an injection molding process), can be produced in the same printing process. Likewise, all conventional methods of joining technology, such as screw connections, snapping, welding, soldering, gluing, shrink-fitting, but also overmolding and comparable processes, can be used for assembling or integrating the acoustic transducer according to the invention into larger assemblies, structures, apparatus, housings, vehicles, etc., without deviating from the basic idea of the invention.

According to a further aspect of the invention, the edge region, preferably and portions of the inner region, of the magnet arrangement was formed from a first material in a first method step and the, preferably remaining, inner region of the magnet arrangement was subsequently formed from a second, different material in a second method step. Preferably, in a first method step, the edge region of the magnet arrangement and preferably parts of the inner region, in particular webs, as an extension of the edge region inwards, were formed from a first material, which is not very magnetic or not magnetic and is mechanically comparatively stiff and/or strong, and in a further method step, further parts of the inner region of the magnet arrangement, in particular webs, were formed from a second material with hard magnetic properties. This can be an alternative option for implementation.

According to a further aspect of the invention, the edge region includes an elastic material at least in portions. Preferably, the edge region was formed in portions from a third, different elastic material in a third method step. Preferably, in a further, preferably third method step, the edge region of the magnet arrangement was supplemented by one or more partial regions of preferably elastic material. This allows the edge region to be at least partially elastic or elastic in portions. This can be done as part of the multi-stage manufacturing method, in particular injection molding method, by using a corresponding material.

According to a further aspect of the invention, the edge region of the magnet arrangement is formed higher perpendicular to the horizontal than the inner region of the magnet arrangement. This means that the diaphragm can lie directly against the edge region of the magnet arrangement perpendicular to the horizontal and be connected to it by bonding, ultrasonic welding, clamping, or other joining methods. In this manner, a distance perpendicular to the horizontal between the magnetic poles of the inner region of the magnet arrangement and the conductor track of the diaphragm, which is necessary or usual for the vibration capability of the diaphragm and thus for acoustic generation, can be created by the edge region of the magnet arrangement itself. Accordingly, there is no need for an additional structural part as a receiving element or as a support element, which can reduce the manufacturing effort. This would previously be an additional element or structural part, which serves as a support element, as a receiving element, or as a carrier element for support, receiving, or carrying, e.g. by gluing on, the diaphragm or the diaphragm film, the function of which can additionally be taken over by the raised edge region of the magnet arrangement according to the invention. So far, this could also be an element or structural part which, as a “loose” element without connection or without bonding, creates the distance perpendicular to the horizontal between the magnet arrangement and the diaphragm, so that its function can also be additionally taken over by the raised edge region of the magnet arrangement according to the invention.

If the diaphragm is arranged perpendicular to the horizontal between the magnet arrangement and a protective grid, a spacer element can be arranged between the diaphragm and the protective grid as a separate element, component, or structural part in order to achieve a corresponding distance for the vibration deflection of the diaphragm. Alternatively, however, the edge region of the protective grid can also be raised perpendicular to the horizontal towards the diaphragm, as described above with regard to the edge region of the magnet arrangement, in order to achieve the required distance even without an additional spacer element as a separate element, component, or structural part.

According to a further aspect of the invention, the conductor track of the diaphragm is electrically conductively connected to a contact element of the edge region of the magnet arrangement at at least one conductor track end, preferably at both conductor track ends, and the magnet arrangement, preferably the edge region of the magnet arrangement, has, preferably in each case, an outer contact element, which is designed to be electrically conductively contacted, preferably soldered, from outside the magnet arrangement. In this manner, electrical contact can be made with the usually very delicate diaphragm or its conductor track by means of corresponding electrically conductive contacts of the magnet arrangement, which itself is usually much more massive and stable than the diaphragm. On the one hand, this can allow the comparatively thin or filigree design of the diaphragm and, on the other hand, the electrical contacting of the conductor track of the diaphragm, for example by means of comparatively solid electrical contact elements and, in particular, solder joints. For this purpose, the magnet arrangement can be used for electrical bridging between the conductor track of the diaphragm and the connection elements or solder joints that can be electrically contacted from outside the planar-dynamic acoustic transducer. The electrically conductive connection between the end of the conductor track or both ends of the conductor track can be made in particular via contact surfaces and, if necessary, additional electrically conductive adhesive at this point.

According to a further aspect of the invention, the planar-dynamic acoustic transducer has at least one support element, which is arranged perpendicular to the horizontal between the edge region of the magnet arrangement and the diaphragm and which distances the inner region of the magnet arrangement from the diaphragm by means of a hollow inner region. Alternatively, this can be used to create a required or usual distance perpendicular to the horizontal between the magnetic poles of the inner region of the magnet arrangement and the conductor track of the diaphragm, for which an additional structural part is required as a support element or as a receiving element, but the design of the magnet arrangement can be simplified.

According to a further aspect of the invention, the conductor track of the diaphragm is electrically conductively connected to a contact element of the support element at at least one conductor track end, preferably at both conductor track ends, and the support element has, preferably in each case, an outer contact element, which is designed to be electrically conductively contacted, preferably soldered, from outside the magnet arrangement. In this manner, the properties and advantages described above can alternatively be realized if a support element is provided perpendicular to the horizontal in order to achieve the necessary distance perpendicular to the horizontal between the magnetic poles of the magnet arrangement and the conductor track of the diaphragm without the magnet arrangement being raised at the edges. This can also allow the implementation of the previously described aspect of electrical contacting in this case as described above, wherein the electrical contacting can then be made from outside the planar-dynamic acoustic transducer on the support element.

According to a further aspect of the invention, the acoustic aperture of the magnet arrangement follows the course of the conductor track of the diaphragm at least substantially, preferably completely. In other words, the acoustic aperture of the magnet arrangement and the conductor track of the diaphragm overlap at least substantially, preferably completely, when viewed in the direction perpendicular to the horizontal. In this manner, unequal magnetic poles are provided on both sides of each conductor track portion and parallel to it. The field lines running between these magnetic poles are optimally aligned tangentially to the conductor track due to this arrangement and have an almost constant density over the entire length of the conductor track. As a result, the magnetic material used can be optimally utilized and a particularly evenly distributed drive force can be achieved across the diaphragm surface.

According to a further aspect of the invention, the acoustic aperture of the magnet arrangement and the conductor track of the diaphragm extend substantially elongate and parallel to one another in the direction of greatest extent of the magnet arrangement. For this purpose, at least the acoustic aperture of the magnet arrangement and the conductor track of the diaphragm can be rectangular or oval with an elongated extension in the horizontal. The rectangular or oval design represent preferred options for the overall shape of the magnet arrangement and thus also of the entire planar-dynamic acoustic transducer in order to realize a preferred or largest extension. In any case, the number of parallel conductor track segments and connecting pieces (sweeps) can be kept to a minimum, which can simplify the manufacture of the magnet arrangement. This can also reduce the number of portions of the conductor track that contribute comparatively little to the drive of the planar-dynamic acoustic transducer near the edge region of the magnet arrangement, but increase the length of the conductor track and thus its electrical resistance, as the electrical current and thus the drive force during operation can decrease with the length of the conductor track and thus also with the increased value of the electrical resistance of the conductor track.

According to a further aspect of the invention, the edge region of the magnet arrangement has at least one guide tenon, preferably a pair of guide tenons, and the diaphragm, preferably and a support element and/or a spacer element and/or a protective grid, at least one through-opening, preferably a pair of through-openings, for the guide tenon of the magnet arrangement. This also allows the edge region of the magnet arrangement to take on an additional mechanical function and facilitate assembly by means of the guide tenons and improve the fit or the matching of the magnet arrangement and diaphragm, and possibly also other elements or components of the planar-dynamic acoustic transducer, in that the diaphragm and possibly other elements, components, or structural parts can be placed on the guide tenon(s) and thus guided and arranged in a defined manner relative to the magnet arrangement. This can be achieved in particular by a pair of guide tenons. However, more than just two guide tenons can also be used, which can improve the guidance accordingly despite the increased effort.

Preferably, the ends of the guide tenons can be formed by the application of force and/or heat after assembly of the diaphragm and/or the other acoustic transducer components in order to fix the diaphragm and/or the other structural parts. This can ensure a permanent hold while being easy and inexpensive to feedthrough. This can be done all the more effectively the more guide tenons are used, wherein the number of guide tenons, on the other hand, should be appropriately limited in order to keep the effort to a minimum. For example, the use of four to eight guide tenons can represent a compromise between effort and effect.

In any case, when using a plurality of guide tenons, it is advantageous to distribute the guide tenons as evenly as possible in the circumferential direction of the planar-dynamic acoustic transducer. This can benefit both guidance and support.

Alternatively, in the case that the diaphragm is arranged perpendicular to the horizontal between the magnet arrangement and a protective grid, this can also be implemented in such a manner that the guide tenon or guide tenons are arranged at the edge of the protective grid and, in particular, are formed integrally there and the edge region of the magnet arrangement has one or more corresponding through-openings. In this manner, the same effect can be achieved with the same technical means, which only have to be arranged differently with regard to the magnet arrangement and the protective grid.

According to a further aspect of the invention, the edge region of the magnet arrangement has at least one receptacle, preferably a plurality of receptacles, for receiving a fastening means, preferably a screw, and the diaphragm, preferably and a support element and/or a spacer element and/or a protective grid, has at least one through-opening, preferably a plurality of through-openings, for the fastening means. This can allow a mechanically simple and durable connection. In particular, screws can be used for this purpose, which can be particularly easy and non-destructive to remove in order to replace elements or to repair the planar-dynamic acoustic transducer or to separate its individual parts and feed them into the material cycle (recycling). For this purpose, such a receptacle can also be formed as an internal thread or provided with a threaded insert.

According to a further aspect of the invention, the edge region of the magnet arrangement has at least one snap hook, preferably a plurality of snap hooks, for gripping around the diaphragm, preferably or a spacer element or a protective grid, wherein preferably a snap hook head facing away from the magnet arrangement is formed magnetically. In other words, this can be used to provide a catch, latch, or clamp connection for holding and positioning the elements or structural parts of the planar-dynamic acoustic transducer, which can alternatively be implemented simply and inexpensively. In particular, this allows the holding function to be combined with the positioning function in one element or in one step, which can be particularly simple and cost-effective.

Preferably, the snap hook can be magnetically designed, in particular at its upper end perpendicular to the horizontal, in order to magnetically mount other structural parts there, such as ear pads of headphones. This can allow additional functions in a simple, cost-effective and/or space-saving manner.

According to a further aspect of the invention, the edge region has at least one, preferably horizontal, cavity, preferably a plurality of, preferably horizontal, cavities, which is open, preferably to at least one acoustic aperture, particularly preferably to a plurality of acoustic apertures, wherein the length of the cavity and/or the distance between two apertures of the cavity is selected such that at least one acoustic frequency, the wavelength of which is in a predetermined ratio to the length of the cavity and/or the distance between two apertures of the cavity, undergoes resonance and/or reflection.

According to a further aspect of the invention, the inner region, preferably at least one magnetic web, more preferably a plurality of magnetic webs, most preferably all magnetic webs, of the inner region has at least one, preferably horizontal, cavity, preferably a plurality of, preferably horizontal, cavities, which is open, preferably to at least one acoustic aperture, more preferably to a plurality of acoustic apertures, wherein the length of the cavity and/or the distance between two apertures of the cavity is selected such that at least one acoustic frequency, the wavelength of which is in a predetermined ratio to the length of the cavity and/or the distance between two apertures of the cavity, undergoes resonance and/or reflection.

Thus, cavities can be introduced in the inner region and/or in the edge region of the magnet arrangement, preferably horizontally and/or parallel to the largest extent of the magnet arrangement, e.g. by sliders in an injection molding tool, by mechanical post-processing, or by corresponding additive primary shaping, such as laser sintering, 3D printing, and similar. These cavities can be provided with apertures at selected positions through which sound flow can enter and exit. At certain acoustic frequencies, whose wavelength is in a certain ratio to the cavity length or the opening distance, resonances and/or reflections can occur that can overlap with the regular acoustic radiation of the planar-dynamic acoustic transducer. This superposition can be constructive or destructive, depending on the phase position of the resonances and/or reflections. This means that the sound emitted to the outside can be amplified or attenuated at these frequencies.

This allows an acoustically effective shaping of the magnet arrangement to be achieved. This can be done using only the edge region of the magnet arrangement or only the inner region of the magnet arrangement. However, both regions of the magnet arrangement can also be used in combination with one another for this purpose. In any case, the system can be designed for maximum absorption and destructive interference in order to minimize the sound emitted to the outside. Alternatively, the design can also be used to reduce unwanted reflections and standing waves from the rear housing wall in headphones with a closed housing, for example. Alternatively, high frequencies, for example, which are emitted by the diaphragm with reduced acoustic pressure due to its mass inhibition, can be amplified by resonator effects, thus creating a uniform, linear sound impression up to high frequencies.

According to a further aspect of the invention, the inner region is acoustically more transparent in portions, in particular for high acoustic frequencies, and otherwise acoustically less transparent, in particular for high acoustic frequencies. In other words, this concerns the structure of the inner region and provides for shaping of the open regions in a partial region of the inner region in such a manner that this is accompanied by acoustic transparency, in particular also for high acoustic frequencies, while in the remaining region of the grid the open regions are shaped in such a manner that they are acoustically less transparent or not transparent, in particular for high acoustic frequencies. This results in a reduced size of the acoustic opening, which leads to a reduction in the directivity of the acoustic radiation, which is determined by the ratio between the size of the surface radiating outwards and the signal frequency.

According to a further aspect of the invention, the planar-dynamic acoustic transducer has a mirror-symmetrical pair of magnet arrangements surrounding the diaphragm perpendicular to the horizontal. This allows a two-sided arrangement of magnet arrangements relative to the diaphragm, which can expand the design possibilities of the planar-dynamic acoustic transducer. Implementing this by means of two mirror-symmetrical magnet arrangements, which are identical and match one another, can allow the same structural part to be used twice and thus keep manufacturing costs low.

In other words, both magnet arrangements can preferably be largely identical and symmetrical along a main axis. Both magnet arrangements can preferably be mechanically reinforced by their shape and/or by embedding and/or connecting them with stiffening elements.

According to a further aspect of the invention, the magnet arrangement has at least one further inner region, which has magnetic poles and is surrounded by the edge region.

In other words, the edge region is shaped such that it has one or more additional inner regions with magnetic material and an optional receptacle for a diaphragm film with conductor tracks. These additional inner regions can be located next to the first inner region or surround it completely or partially. These inner regions can be operated as further independent acoustic transducers by attaching a diaphragm film with contacted conductor tracks. These can differ from each other and/or from the first acoustic transducer, e.g. in size, grid structure, diaphragm excursion, etc., and are therefore suitable for reproducing different frequency ranges, for example. For this purpose, the various acoustic transducers can be excited with their own electrical signals containing only the relevant signal frequencies. These signals can be generated, for example, by digital signal processing and subsequent digital-to-analog conversion and amplification, or by passive structural parts, such as capacitors or passive filter networks.

The advantage is that the individual acoustic transducers can be dimensioned and optimized for the reproduction of their respective frequency range. For example, low signal frequencies usually require significantly larger diaphragm areas and diaphragm strokes, while high signal frequencies can be emitted by a light diaphragm with a small surface area. This also prevents a strong increase in the directivity of acoustic radiation towards high frequencies.

Particularly small embodiments of the first or an additional grid area and the associated diaphragm are also suitable for use as an electrodynamic microphone.

The above-mentioned different acoustic transducers can also be similarly or identically shaped and excited with different digital-to-analog converted and amplified signals, e.g. generated by digital signal processing, such as beamforming or wave field synthesis, in order to obtain, for example, a controllable directivity of the acoustic radiation or the simulation of arbitrarily shaped acoustic wave fronts. In this manner, a localized sound or a virtual acoustic environment can be created.

According to a further aspect of the invention, the magnet arrangement has at least one further inner region, which is free of magnetic poles and is surrounded by the edge region. The further inner region can also be referred to as the second inner region, to distinguish it from the inner region previously considered alone as the first inner region.

In other words, the edge region is shaped such that it has one or more additional inner regions without magnetic material and with an optional receptacle for a diaphragm film. These additional inner regions can be located next to the first inner region or surround it completely or partially. These inner regions can be operated as so-called passive radiators by attaching a diaphragm film. These can differ from one another and/or from the first acoustic transducer, e.g. in size, grid structure, diaphragm stroke, etc. and, in conjunction with the coupled air volumes, have corresponding first-order resonant frequencies. In order to adjust this resonant frequency and, for example, to obtain a desired low value, the pretension and mass of the diaphragm film can be varied, e.g. by varying the film thickness or by mechanically structuring (corrugation, embossing, or similar) the diaphragm film or by using additional materials with mass that are permanently bonded to the diaphragm film, for example by gluing, laminating, overmolding, or similar. The passive radiator(s) can be strongly acoustically coupled to the active acoustic transducer(s) at the rear by common volumes of air separated from the surroundings, so that they are excited to a resonance by these at certain signal frequencies, which is accompanied by a phase shift. As a result, an additional acoustic radiation of certain frequencies is obtained, which is predominantly superimposed on the acoustic radiation of the active acoustic transducer(s) by design and thus increases the total sound energy emitted at these frequencies, for example in the bass range.

According to a further aspect of the invention, the edge region of the magnet arrangement has at least one additional wall, which extends substantially outside the horizontal and acoustically separates the inner region of the magnet arrangement from the further inner region. In particular, the additional second wall may extend substantially to exactly perpendicular to the horizontal or extend away from the edge region, which may be considered to extend in the horizontal. In any case, the additional wall can provide structural and/or acoustic separation.

According to a further aspect of the invention, the edge region of the magnet arrangement is formed as a baffle.

In other words, the edge region is shaped in such a manner that it fulfills the function of a baffle, i.e. it largely prevents an acoustic short-circuit between the front and back of the diaphragm in the relevant frequency range and thus improves the reproduction of low audio frequencies (e.g. bass tones). For this purpose, the edge region can be enlarged to such an extent that a sufficiently long detour is created for the acoustic wave generated at the rear, so that at the desired sound reception location at the lowest relevant signal frequency, it is only minimally destructively superimposed with the acoustic wave generated at the front, i.e. the phase difference between these two acoustic waves is reduced from the original 180° to less than 140° (maximum amplitude reduction of around 3 dB due to destructive interference). In the same manufacturing process, additional functional features, such as recesses, bores, hooks, bolts, bars, etc., can be created, e.g. for assembly with and spacing from other structural parts and structures.

Alternatively, the edge region can also be shaped to form front and/or side walls of a speaker enclosure and have features such as bores, threads, snap hooks, etc., for attaching one or more structural parts that form side and/or rear walls. In this manner, a fully or partially closed loudspeaker enclosure can be formed. This prevents or reduces the acoustic short-circuit even if the dimensions are significantly smaller than those required for the above-mentioned baffle.

In the interests of efficient and integrated production, the edge region extended to form the baffle or speaker enclosure part can also be incorporated into other structural parts, such as a flat enclosure, bodywork, or trim component, such as an enclosure part of a screen or a luminaire, an outer surface of a piece of furniture or a ceiling suspension, or an interior trim of an automobile, and can be produced in whole or in part together with said structural part in the same injection molding process.

In addition, the edge region may have further walls, preferably extending substantially perpendicular to the diaphragm plane, between the drive region and the outer edge of the edge region. These further walls, possibly in conjunction with the separate rear wall, can form an acoustic channel of defined length, which guides sound energy from the rear of the membrane to an acoustic outlet located in one of the outer housing walls. Thus, depending on the length and cross-sectional surface of the channel, either an acoustic bypass similar to that of the baffle described above is formed, but with significantly smaller dimensions than those required for the above-mentioned baffle.

Or a resonance system is formed, consisting of the air in the channel (moving mass) and the air outside the channel in the closed housing (acoustic spring), which causes increased acoustic radiation at the resonance frequency.

The shape and/or surface area of the acoustic channel can be constant or variable over its length, and it can be straight, curved or angled; accordingly, for example, a horn, an inverted horn, or a so-called transmission line is formed. These further walls can also divide the housing volume, possibly in conjunction with the separate rear wall, for example to provide each acoustic transducer with an independent air volume if more than one active acoustic transducer is present.

According to a further aspect of the invention, the edge region of the magnet arrangement has at least one wall extending substantially outside the horizontal, which wall encloses at least one inner region at least in portions. In other words, parts of the edge region of the magnet arrangement may be formed as one or more walls extending substantially outside the horizontal, which partially or completely enclose at least one inner region. Optionally, this wall can also be designed as a rear wall of an enclosure connected by a film hinge, for example.

This allows a panel or wall to be formed as a lateral boundary, preferably in one piece with the edge region, which can increase the design freedom. This can also increase the stability of the magnet arrangement.

According to a further aspect of the invention, the magnet arrangement together with a rear wall forms an enclosure of the planar-dynamic acoustic transducer. This can be used to create an encapsulated or enclosed space.

Preferably, the rear wall is connected to the wall of the edge region of the magnet arrangement, preferably by a film hinge, preferably in one piece, which can simplify assembly and manufacture.

According to a further aspect of the invention, the edge region of the magnet arrangement has at least one wall that extends substantially outside the horizontal and forms at least one acoustic channel, which is designed to communicate acoustically with the air volume above the inner region and with the surrounding atmosphere. In other words, the edge region of the magnet arrangement has one or more additional walls that extend substantially outside the horizontal and that form one or more acoustic channels, which communicate acoustically with the volume of air above the inner region or with the volume of air above one or more optional further inner regions and the surrounding atmosphere. This can increase the design options.

According to a further aspect of the invention, the edge region of the magnet arrangement has at least one surface element, preferably extending substantially in the horizontal, preferably formed in one piece. In other words, the edge region of the magnet arrangement can have one or more further surface elements, which can be used for assembly or integration into larger assemblies, apparatus, or vehicles. This can facilitate the assembly of the planar-dynamic acoustic transducer.

The present invention also relates to a magnet arrangement for use in a planar-dynamic acoustic transducer as previously described. In this manner, a magnet arrangement can be made available as a structural part or as an assembly in order to implement a planar-dynamic acoustic transducer according to the invention as described above and to be able to utilize its properties and advantages.

The present invention also relates to an earphone, preferably a headphone, having at least one planar-dynamic acoustic transducer as previously described. In this manner, the properties and advantages of a planar-dynamic acoustic transducer according to the invention as described above can be implemented and utilized in an earphone and in particular headphones.

The present invention also relates to a microphone having at least one planar-dynamic acoustic transducer as previously described. In this manner, the properties and advantages of a planar-dynamic acoustic transducer according to the invention can be implemented and utilized in a microphone as described above.

The present invention also relates to a loudspeaker comprising at least one planar-dynamic acoustic transducer as previously described. In this manner, the properties and advantages of a planar-dynamic acoustic transducer according to the invention can be implemented and utilized in a loudspeaker as described above.

The present invention relates to a loudspeaker-microphone combination with at least one planar-dynamic acoustic transducer as described above, wherein at least the inner region with an associated first diaphragm is configured as a loudspeaker and at least the further inner region with an associated further diaphragm is configured as a microphone. This can be an advantageous way of implementing or utilizing the corresponding properties and benefits.

In other words, the present invention relates to a magnet arrangement, which may also be referred to as a magnet grid or a magnet system. The magnet arrangement can be manufactured in one piece (monolithically) with suitable sound passage apertures, e.g. by milling, injection molding, die casting, metal powder injection molding, compression molding, 3D printing, or the like, and can be made of a suitable material, such as a plastics matrix (e.g. polyamide 6 or 12), which can be filled with hard magnetic particles, such as neodymium iron boron at least or exactly in the inner region. The degree of filling of the hard magnetic particles in the surrounding material can be as high as possible for high efficiency of the acoustic transducer, but can be adjusted depending on the requirements of the part geometry and the manufacturing process. When using anisotropic particles, a suitable magnetic field can be applied during the primary molding process or in a downstream step to mechanically align the magnetic particles, e.g. using permanent or electromagnets in the injection mold.

Aspects of the invention may in particular be the following, in addition or alternatively to one another:
A planar-dynamic acoustic transducer with a multipole magnetized grid made of a material containing hard magnetic material, substantially consisting of one to four individual parts, as well as a substantially planar diaphragm film positioned substantially parallel and in direct proximity to the grid, with conductor tracks located thereon, which generate a substantially normal-area force when current flows through interaction with the magnetic field of the grid, wherein the magnetic grid has additional specific properties or formations and/or elements and/or features beyond the provision of the magnetic field required directly for acoustic generation, which are beneficial to the power, quality and/or assembly of the acoustic transducer and/or the product.

The special feature of this aspect according to the invention can be seen in the shaping and construction of the magnetic grid to improve the properties and/or the power as an acoustic transducer or to increase the functionality in order to realize higher benefits, better quality, and lower costs. Specific features are explained below.

The magnet arrangement or magnet grid may have additional mechanical and/or magnetic features, such as assembly bores, studs, recesses, snap hooks, spacer stages, carrier stages, magnetic poles outside the movable diaphragm surface, etc., which may allow the positioning, alignment, spacing and/or mounting of additional components or elements, such as a diaphragm film, a protective grid, an acoustic damping material, a housing, an ear pad, a second mirrored magnet grid, etc.

As described above, the planar-dynamic acoustic transducer and the associated product can thus have other structural parts in addition to the magnetic grid, which can or must be positioned and fixed relative to one another. The magnet grid may have various elements or features that facilitate these purposes or replace some structural parts or aids. Examples of this are:
a. Guide tenons: These can be made of the same base material as the magnet grid and thus form a natural unit with it, i.e. be integral with one another, or they can be firmly connected to the magnet grid during production, e.g. by injection molding or 3D printing, approximately by placing them as an insert in the mold and injecting the moldable magnetic material around them, thus forming a solid unit with it. One or more such studs can make it possible to “thread” or position the other structural parts using corresponding bores or recesses. Conversely, such studs can also be connected to another structural part and inserted into corresponding bores in the magnet grid. A combination is also possible, i.e. for example the magnet grid can have a guide tenon on one side and a bore on the symmetrically opposite side; now a second similar magnet grid, rotated by 180°, can be connected to the first magnet grid and aligned over both tenons to obtain a symmetrical drive system with two opposing magnet grids.
b. Snap hooks: These can be barbs that are slightly deformed during assembly in order to spring back into their original shape behind the joining partner and create a positive fit that fixes the structural parts and does not require any further work steps or aids, such as adhesive, screws, rivets, or similar. At the same time, snap hooks can also have a guiding and alignment function, like the guide tenons under point a. When forming the magnet grid, snap hooks, and similar functions can be formed from the base material and form a natural unit with the magnet grid, or separate hooks, e.g. made of spring steel, can be used and connected to the magnet grid (e.g. overmolded) during the forming process.
c. Distance and carrier stages: Some structural parts, such as the diaphragm film, can be positioned and fixed at a defined distance from the magnet grid. For this purpose, the magnet grid can have a circumferential step of appropriate height, which creates this distance, and which may also be the direct carrier of the diaphragm film by mounting it on the circumferential step by gluing, clamping, or other methods. Similar solutions can also be realized for other structural parts, such as protective grids, dust protection, seals, acoustic damping elements, etc.

d. Bores: If the various structural parts are to be connected to one another or to a housing or similar with the help of screws, a holding frame can be used in conventional design, which holds the magnet arrangement and has bores. According to the invention, the magnet grid can contain these bores, which can either be through-holes for screws or threaded holes (possibly with threaded inserts or press-in nuts) for metric or self-tapping screws. This reduces or eliminates the additional work, tolerance risks, and costs that can be associated with the conventional assembly of, for example, ten magnetic rods and a holding frame.
e. Additional magnetic poles: Due to the underlying manufacturing method of the magnet grid, hard magnetic material is also available outside the actual drive area (near the conductor tracks) and can be magnetized if required. These additional magnetic poles can be used to attract other permanent or electromagnets or ferromagnetic structural parts and thus position and fix them in place. Examples of this are protective grids made of steel or ear pads with integrated carrier rings made of steel or integrated individual magnets. These structural parts can be removed and reattached without tools or auxiliary materials, which can be particularly advantageous for the end user. These magnetic poles do not have to be located at the level of the drive region, but can also be located on raised regions, such as the top of the snap hooks or guide tenons or the outside of the magnet grid to allow this functionality where it is needed.

The magnet arrangement or magnet grid can have the same functionality as before, but with reduced overall weight and or cost, by using lighter and or less expensive materials or elements that can be permanently attached to or enclosed by the magnet grid and thus locally replace the hard magnetic material.

This aspect of the invention is based on the realization that hard magnetic material, such as neodymium iron boron, has a relatively high density and is usually associated with relatively high raw material costs. Therefore, in regions that do not require magnetic functionality, this material can be replaced by other materials that have a lower cost and/or density. In the case that the hard magnetic material is used as a filler in a plastics matrix, the same type of plastics can be used in the non-magnetic regions in particular, but without a filler, thus enabling a good material bond between the regions. But other plastics, foamed materials, wood, and many other materials can also be considered. The non-magnetic regions, provided they are in a plastics state, can either be printed or injection-molded together with the other regions using 2K production, or they can be produced upstream and placed as an insert in the mold or on the printing form and integrated and firmly bonded to the hard-magnetic region during the primary molding process.

The magnet arrangement or the magnet grid can have features and/or integrated elements for the electrical contacting of the conductor tracks located on the diaphragm film, e.g. contact surfaces, solder surfaces, bond pads, solder lugs, etc.

This aspect of the invention is based on the realization that electrical contacting between the conductor track and the leads can be challenging, as the conductor track and diaphragm film can in many cases be very thin and temperature sensitive, so that soldering or bonding may not be possible. One solution according to the invention can be to press flat metallic parts onto the ends of the conductor track, possibly combined with a conductive adhesive. These contact parts or the open ends of the conductor tracks, if necessary with a correspondingly flat and/or thick design, can themselves allow a soldered connection to the supply lines and can be integrated into the magnet grid as inserts, for example, in order to allow stable and easy-to-establish contacting. This contacting method can be very advantageous, especially if the acoustic transducer is symmetrical as described above and consists of only two magnet grids and the diaphragm with conductor track. If necessary, some surfaces of the contact parts can be electrically insulated, e.g. by painting, to prevent an electrical shunt through the magnetic material.

The magnet arrangement or the magnet grid can be mechanically reinforced and/or stiffened by its shape and/or by elements that are firmly connected to or enclosed by the magnet arrangement or the magnet grid in order to achieve greater robustness for demanding applications and/or to be able to permanently bear the repulsive forces in a symmetrical structure consisting of two mirrored magnet grids arranged in close proximity to one another.

This means that the magnet arrangement or the magnet grid for the core functionality of providing a magnetic field in the drive region can be relatively thin, e.g. approx. 1 mm thick. In this embodiment, however, the stability and/or the strength of the magnet arrangement and/or the magnet grid may be jeopardized, as the hard magnetic material can be brittle and fragile, especially if significant forces act on the magnet arrangement and/or the magnet grid. Dynamic forces can arise during use due to collisions or falling, while static forces can arise in particular with a symmetrical structure consisting of two magnet grids that repel one another. To increase the stability of the magnet arrangement or the magnet grid, it can be reinforced by suitable structural stiffeners, struts, etc. Alternatively or additionally, other parts or materials can be integrated into the magnet arrangement or the magnet grid, e.g. inserts, 2K injection molding, carbon fibers, steel rods, metal sheets, etc.

The magnet arrangement or the magnet grid can be substantially symmetrical to at least one axis in order to allow the use of a second similar magnet grid for a symmetrical structure consisting of two mirrored magnet grids. For a symmetrical structure consisting of two opposing magnet grids, it can be advantageous if the same magnet grid can be used twice. In order to allow the 180° rotation required for this, it can be advantageous if the magnet grid has at least one axis of symmetry in itself, apart from individual features as described above.

The magnet arrangement or the magnet grid can have acoustic properties that influence the sound field, the acoustic pressure, the sound velocity or the sound flow in the vicinity of the acoustic transducer or shape it depending on frequency or amplitude or influence the vibration behavior of the diaphragm film or other elements in order to reduce or deliberately shape non-linear distortions or frequency-dependent amplitude fluctuations in the generated sound signal.

The magnet arrangement or the magnet grid can be designed for full acoustic transparency in its grid structure, i.e. the degree of aperture and/or the shape of the apertures it contains. Alternatively, it can also have a defined acoustic resistance in order to realize damping of unwanted vibration modes and non-linear distortions of the diaphragm. Or it may have regions that generate acoustic resonance and thus amplify or attenuate certain acoustic frequencies. Several acoustic paths with different path lengths and/or resonance frequencies can be realized in the same magnet grid in order to be able to influence different frequency ranges. Furthermore, (additional) regions of the magnet grid can be embodied in a different, e.g. porous and thus acoustically absorbent material, preferably either as an insert or by 2K production, in order to influence the sound flow or, for example, to reduce unwanted reflections and modes. In this manner, the various quantities of acoustic pressure, speed, flow, and radiation can be shaped to achieve a certain sound quality and signature.

In regions adjacent to the higher-level assembly (e.g. housing), the magnet arrangement or magnet grid can be made of an elastic material that provides an acoustic seal and decouples structure-borne noise and compensates for mechanical tolerances.

This aspect of the invention is based on the realization that elastic elements, such as seals made of foam or silicone, are often inserted between the acoustic transducer and the housing. These elements can be integrated into the magnet grid as inserts or by 2K production, as mentioned above, in order to save the corresponding work step during assembly. The aim can be sealing to prevent an acoustic short-circuit between the front and rear of the acoustic transducer on the one hand, and mechanical decoupling to reduce the transmission and audibility of structure-borne noise from the housing, cable, or other parts to the acoustic transducer on the other. It is also possible to compensate for possible mechanical tolerances, i.e. mechanical dimensions and properties that vary during series production, by deforming the elastic material to a greater or lesser extent.

The magnet arrangement or the magnet grid, i.e. the arrangement and shaping of bars and recesses, can substantially map the course of the conductor tracks on the diaphragm film and in particular in the region of the connecting pieces, sweeps, etc., directly or inversely in order to focus the permanent magnetic field as evenly as possible on all portions of the conductor tracks.

This aspect of the invention is based on the realization that conventional implementations use magnetic rods that run parallel to the conductor tracks. The freedom of shaping of the monolithic magnet grid according to the invention can also allow the sweeps or connections between the parallel conductor track segments to be followed exactly, either directly or inversely, and thus also generate a constant magnetic field there and thus a homogeneous driving force over the entire membrane surface.

The conductor tracks and the corresponding magnetic poles of the grid can run in the direction of the longest extension of the acoustic transducer (e.g. the long semi-axis of an ellipse) in order to keep the number of parallel conductor track segments and the number of connecting pieces (sweeps) low. Thus, building on the previous aspect, it can also be advantageous if the parallel conductor track segments and the corresponding grid structure run in the direction of the longest extension of the acoustic transducer in order to minimize the number and length of the turns or connecting pieces. This simplifies the production of the grid and minimizes the number of conductor track pieces, which contribute little to the drive of the acoustic transducer in the edge region, but increase the conductor length and electrical resistance, which can reduce the electrical current and thus the driving force.

Overall, the aspects and features of the invention mean that a comparatively very small number of individual parts are required. Accordingly, the assembly and quality assurance effort can be very low and allow economical production at or below the cost level of conventional dynamic or moving coil acoustic transducers. Furthermore, the significantly improved sound quality of a planar-dynamic acoustic transducer can be made available to a considerably wider customer base.

Several exemplary embodiments and further advantages of the invention are illustrated and explained in more detail below, purely schematically, in connection with the following figures. Shown are:

FIG. 1 is a perspective schematic exploded view of a planar-dynamic acoustic transducer according to a first embodiment from an oblique top view;

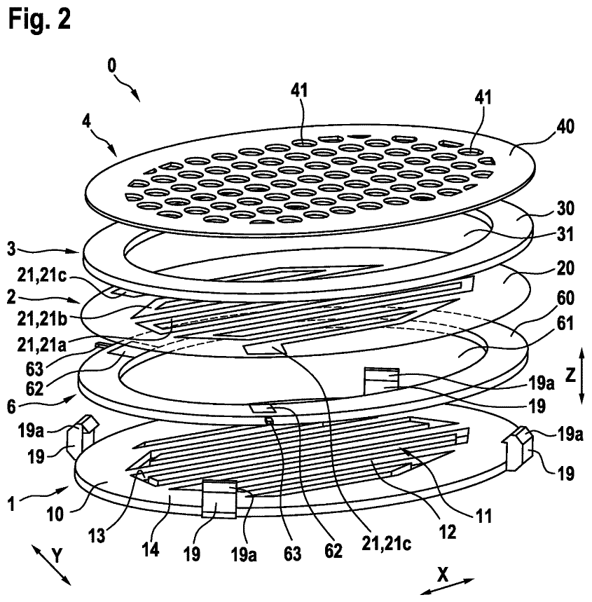

FIG. 2 is a perspective schematic exploded view of a planar-dynamic acoustic transducer according to a second embodiment from an oblique top view;

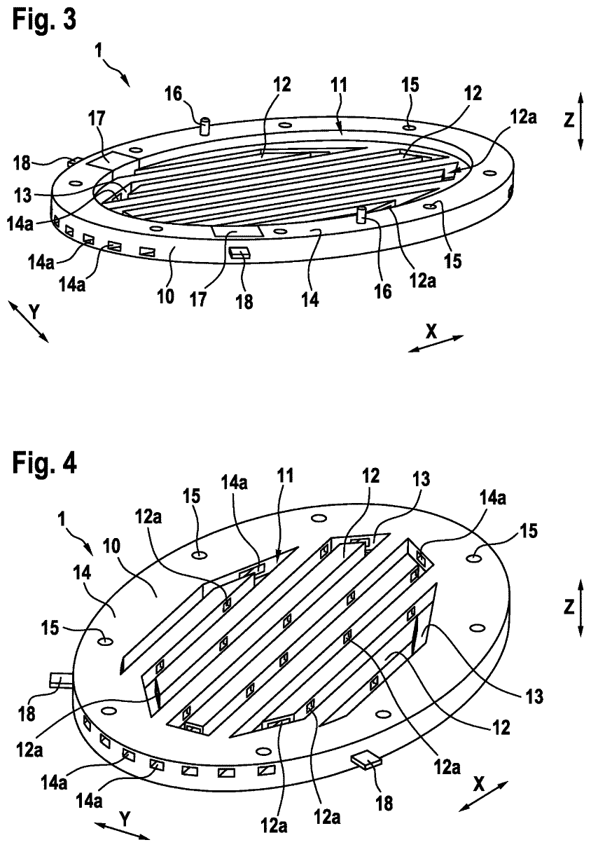

FIG. 3 is a schematic perspective view of a magnet arrangement of a planar-dynamic acoustic transducer according to a third embodiment from an oblique top view;

FIG. 4 shows FIG. 3 from below;

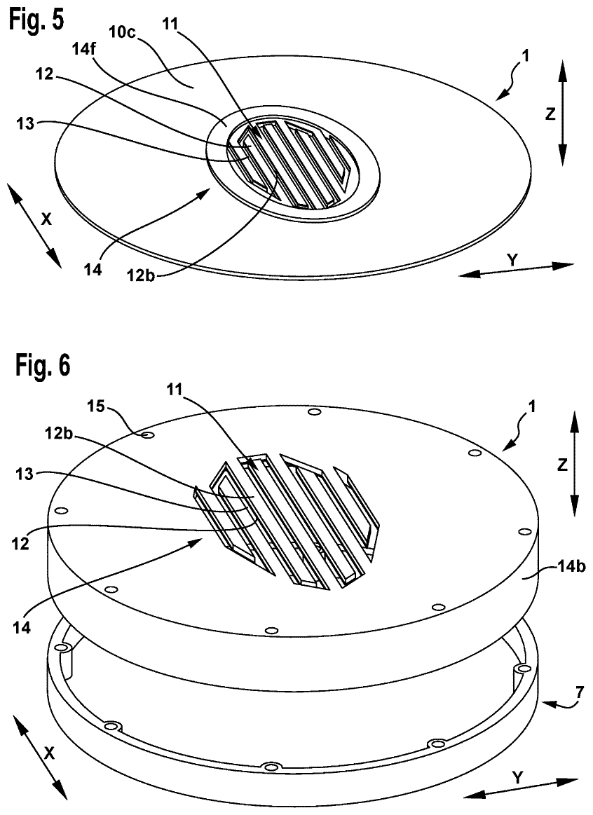

FIG. 5 is a perspective cross-sectional view of a magnet arrangement of a planar-dynamic acoustic transducer according to a fourth embodiment from an oblique top view;

FIG. 6 is a perspective cross-sectional view of a magnet arrangement of a planar-dynamic acoustic transducer according to a fifth embodiment from diagonally below;

FIG. 7 is a perspective cross-sectional view of a magnet arrangement of a planar-dynamic acoustic transducer according to a sixth embodiment from an oblique top view;

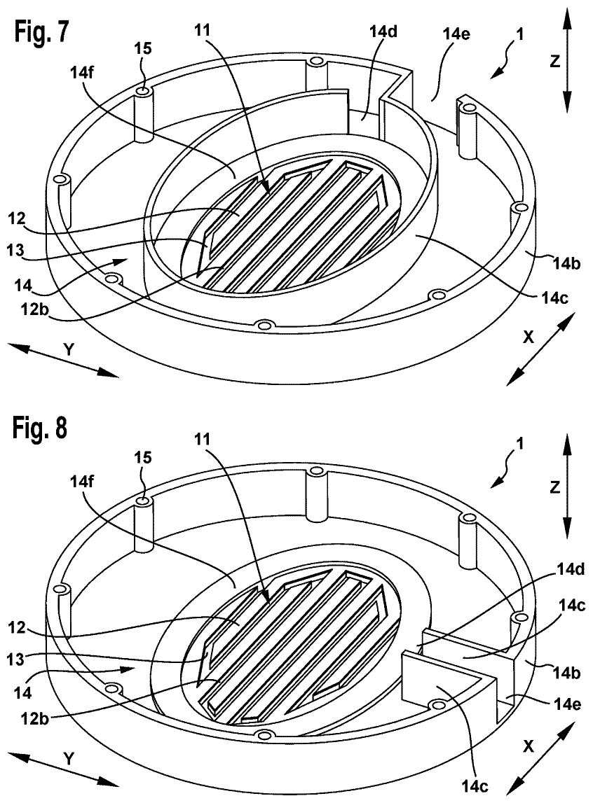

FIG. 8 is a perspective cross-sectional view of a magnet arrangement of a planar-dynamic acoustic transducer according to a seventh embodiment from an oblique top view;

FIG. 9 is a perspective cross-sectional view of a magnet arrangement of a planar-dynamic acoustic transducer according to an eighth embodiment from an oblique top view;

FIG. 10 is a perspective cross-sectional view of a magnet arrangement of a planar-dynamic acoustic transducer according to a ninth embodiment from an oblique top view;

FIG. 11 is a perspective cross-sectional view of a magnet arrangement of a planar-dynamic acoustic transducer according to a tenth embodiment from an oblique top view;

FIG. 12 is a perspective cross-sectional view of a magnet arrangement of a planar-dynamic acoustic transducer according to an eleventh embodiment from an oblique top view;

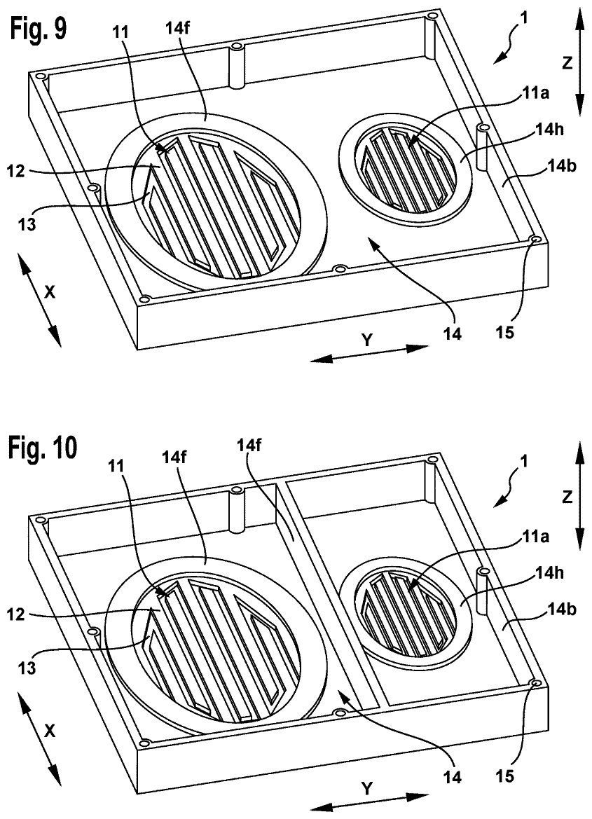

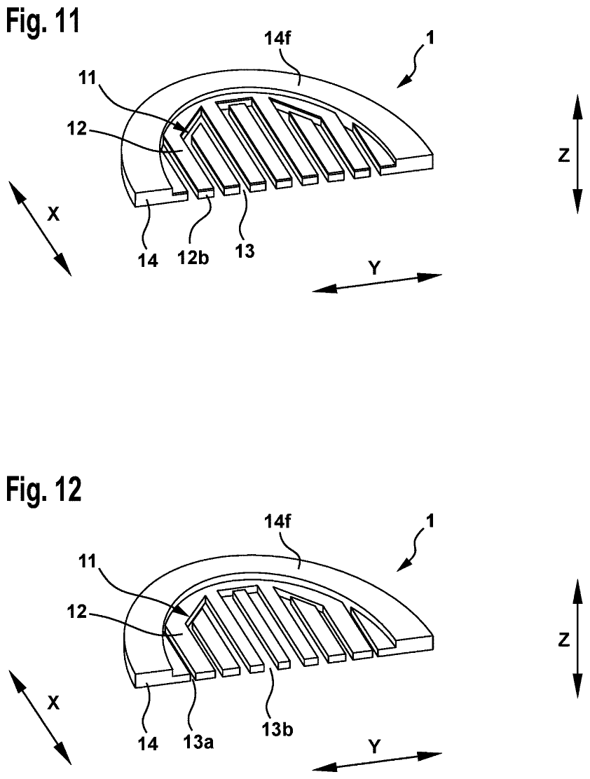

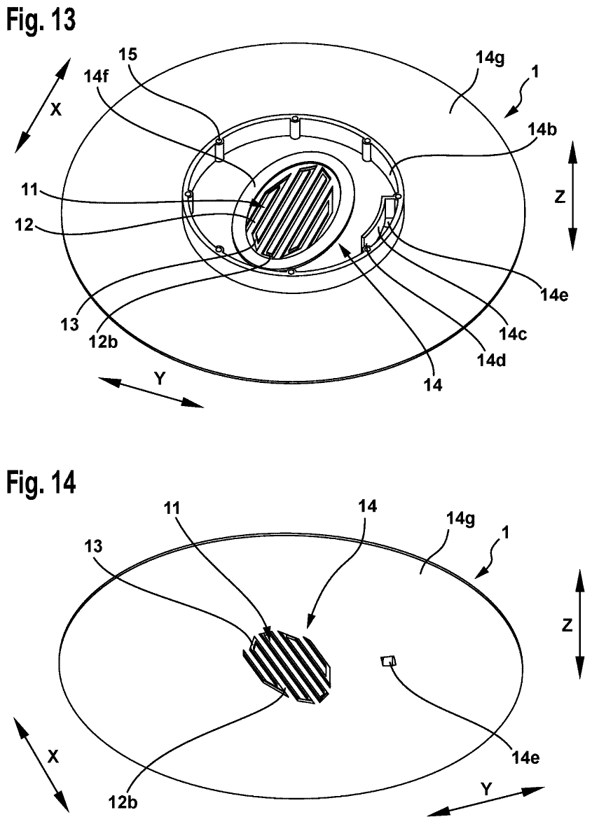

FIG. 13 is a perspective cross-sectional view of a magnet arrangement of a planar-dynamic acoustic transducer according to a twelfth embodiment from an oblique top view; and

FIG. 14 shows FIG. 13 from below;

The above figures are viewed in Cartesian coordinates. A longitudinal direction X is shown, which can also be referred to as depth X or as length X. A transverse direction Y, which can also be referred to as width Y, extends perpendicular to the longitudinal direction X. A vertical direction Z extends perpendicular to both the longitudinal direction X and the transverse direction Y, which can also be referred to as height Z and which corresponds to the direction of gravity. The longitudinal direction X and the transverse direction Y together form the horizontal X, Y, which can also be referred to as horizontal plane X, Y.

According to the first embodiment example of FIG. 1, a planar-dynamic acoustic transducer 0 has, viewed in the vertical direction Z or perpendicular to the horizontal X, Y from bottom to top, a magnet arrangement 1, a diaphragm 2, a spacer element 3 and a protective grid 4, which in the assembled state (not shown) are held together by fastening means 5 in the form of screws 5. The screws 5 can be removed non-destructively for repair or disassembly. The planar-dynamic acoustic transducer 0 or its corresponding elements, components, or structural parts are substantially flat or planar in the horizontal X, Y and extend there oval with the longitudinal direction X as the preferred direction of extension.

The magnet arrangement 1, which can also be referred to as magnet grid 1, is formed in one piece, i.e. integrally or in one piece, as magnet body 1. The magnet arrangement 1 has an inner region 11, which in the first embodiment example is formed as a depression 11 opposite an edge region 14. In this inner region 11, magnetic bars 12 with magnetic poles and acoustic apertures 13 are formed, which run parallel to the magnetic bars 12 in the longitudinal direction X and surround the magnetic bars 12 at one end and are spaced apart from each other in the transverse direction Y. The magnetic bars 12 are each connected to one another at the opposite end via the edge region 14 already mentioned.

The diaphragm 2, which is formed as a comparatively thin diaphragm film 2, preferably less than 10 μm thick, is also formed in one piece by a diaphragm body 20 made of a flexible material. A conductor track 21 made of electrically conductive material is applied to the diaphragm 2, which runs congruently with the acoustic apertures 13 of the magnet arrangement 1. Accordingly, longitudinal portions 21a of the conductor track 21 run parallel to the acoustic apertures 13 in the longitudinal direction X and sweeps 21b of the conductor track 21 encircle the open ends of the magnetic bars 12 in the transverse direction Y.

The spacer element 3, which can also be referred to as the first ring 3, has a spacer element body 30, which is also formed in one piece. The spacer element 3 has an oval inner region 31 as a material-free through-opening in the vertical direction Z or perpendicular to the horizontal X, Y, so that the spacer element body 30 oval encloses the hollow inner region 31.

The protective grid 4 closes off the planar-dynamic acoustic transducer 0 in the vertical direction Z or perpendicular to the horizontal X, Y as shown in FIG. 1. The protective grid 4 is also formed in one piece as a protective grid body 40. In the inner region (not indicated), the protective grid body 40 has a plurality of acoustic apertures 41, each of which is circular and evenly distributed and is surrounded by the protective grid body 40.

According to the invention, the edge region 14 has further mechanical, acoustic, and electrical functions. This can extend the range of functions of the planar-dynamic acoustic transducer 0, improve its properties or quality and/or simplify its manufacture and in particular its assembly.

As a mechanical function of the planar-dynamic acoustic transducer 0, the holding of the elements, components, or structural parts is improved according to the invention in that the edge region 14 of the magnet arrangement 1 has a plurality of receptacles 15 distributed evenly in the circumferential direction in the form of bores 15 with internal threads, which can each accommodate the corresponding external threads of the screws 5. This allows simple and safe assembly. The diaphragm 2 has corresponding through-openings 22 for fastening means 5 or for screws 5 on the edge side, the spacer element 3 has corresponding through-openings 32 for fastening means 5 or for screws 5 on the edge side and the protective grid 4 has corresponding through-openings 42 for fastening means 5 or for screws 5 on the edge side, which are congruent with each other in the mounted state, so that the screws 5 can reach the receptacles 15 of the edge region 14 of the magnet arrangement 1. This can allow easy assembly with a secure hold.

In order to bring the receptacle 15 of the edge region 14 of the magnet arrangement 1 as simply, quickly, and reliably as possible into alignment with the through-openings 22 for fastening means 5 or for screws 5 of the diaphragm 2, with the through-openings 32 for fastening means 5 or for screws 5 of the spacer element 3 and with the through-openings 42 for fastening means 5 or for screws 5 of the protective grid 4, the edge region 15 of the magnet arrangement 1 also has a pair of guide tenons 16 in the form of guide pins 16, which are diametrically opposite one another. The diaphragm 2 has a corresponding pair of through-openings 23 for guide tenons 16 of the magnet arrangement 1. Accordingly, the spacer element 3 also has a pair of through-openings 33 for guide tenons 16 of the magnet arrangement 1. This applies accordingly to the protective grid 4, which in turn has a pair of through-openings 43 for guide tenons 16 of the magnet arrangement 1.

These through-openings 23, 33, 43 for guide tenons 16 of the magnet arrangement 1 are also arranged corresponding to one another, so that the diaphragm 2, the spacer element 3 and finally the protective grid 4 can be positioned and held one after the other or together by means of the guide tenons 16 of the magnet arrangement 1 and in alignment with one another, so that the screws 5 can then be screwed in as described above. This can further simplify assembly and, in particular, positioning and alignment.

According to the invention, the electrical function of the planar-dynamic acoustic transducer 0 is to allow the conductor track 21 of the diaphragm 2 to make contact with the edge region 14 of the magnet arrangement 1. For this purpose, the two conductor track ends 21c are formed flat as contact points 21c of the conductor track 21 and are connected in the vertical direction Z or pointing downwards perpendicular to the horizontal X, Y by means of an electrically conductive adhesive to a corresponding contact element 17 or to a corresponding contact surface 17 for conductor tracks 21 of the diaphragm 2, so that there is an electrical connection between the diaphragm 2 and the magnet arrangement 1 at these two points. Through the magnet body 10, the two contact surfaces 17 for conductor tracks 21 of the diaphragm 2 of the magnet arrangement 1 are electrically conductively connected to outer contact elements 18 of the magnet body 1, which point radially outwards from the edge region 14 of the magnet arrangement 1, in the form of outer contact pins 18.

The two outer contact pins 18 of the edge region 14 of the magnet arrangement 1 are sufficiently solid so that electrical contact can be made from outside the planar-dynamic acoustic transducer 0 by soldering the two outer contact pins 18 of the edge region 14 of the magnet arrangement 1 in order to electrically feed the conductor track 21 of the diaphragm 2 and thus operate the planar-dynamic acoustic transducer 0. Direct electrical contacting of the conductor track ends 21c of the conductor track 21 of the diaphragm 2 from the outside can thus be omitted, as a result of which the conductor track 21 of the diaphragm 2 or the diaphragm 2 can be made comparatively thin or filigree and still be electrically contacted.

In any case, the magnet body 10 of the magnet arrangement 1 can be formed in one piece, for example by means of a two-component injection molding method (2K injection molding method), so that a plastics material, such as a polyamide, is present in the inner region, in which permanent magnetic or hard magnetic particles, such as those made of neodymium iron boron, are embedded. Using the 2K method, this inner region 11 of the magnet body 1 is surrounded in one piece only by the same plastics material, so that the edge region 14 of the magnet body 1 is free of hard magnetic particles. This allows the desired magnetic properties of the magnet arrangement 1 to be achieved in its inner region 11. At the same time, the manufacturing costs of the magnet arrangement 1 can be kept low with regard to the material of the magnet body 10, as the hard magnetic particles in the edge region 14 of the magnet body 1 can be saved.

The planar-dynamic acoustic transducer 1 of the second embodiment example of FIG. 2 substantially corresponds to the planar-dynamic acoustic transducer 1 of the first embodiment example of FIG. 1.

However, the elements, components or structural parts of the planar-dynamic acoustic transducer 1 of the second embodiment example of FIG. 2 are held in place by the fact that four snap-in hooks 19 are formed in one piece on the edge region 14 of the magnet arrangement 1 of the magnet body 10, which can also be referred to as snap-in hooks 19 and which extend upwards in the vertical direction Z or perpendicular to the horizontal X, Y. The hook elements (not indicated) of the snap hooks 19 project radially inwards, wherein the upper surfaces (not indicated) of the hook elements are formed to extend obliquely inwards. The four snap hooks 19 are positioned virtually at the four corners of the oval surface of the magnet arrangement 1.

The edge region 14 of the magnet arrangement 1 is flat or flat with the inner region 11, so that the distance between the magnet arrangement 1 in the vertical direction Z or perpendicular to the horizontal X, Y upwards to the diaphragm 2 is achieved by an additional element, component or structural part in the form of a one-piece support element 6. The support element 6 can also be referred to as the receiving element 6, as it receives the diaphragm 2, or as the second ring 6. The support element 6 also has an oval inner region 61 as a material-free through-opening in the vertical direction Z or perpendicular to the horizontal X, Y, so that the support element body 60 ovally encloses the hollow inner region 61.

The elements, components or structural parts of the planar-dynamic acoustic transducer 1 of the second embodiment example of FIG. 2 are now assembled in such a manner that the support element 6 is first pressed onto the magnet arrangement 1 from above, so that the snap hooks 19 are bent radially outwards in a spring-elastic manner in order to allow the support element body 60 to pass between them. This is also done successively for the diaphragm 2, for the spacer element 3 and for the protective grid 4, which is then gripped from above by the radially inwardly projecting hook elements in the vertical direction Z or perpendicular to the horizontal X, Y and thus held. This means that assembly can be carried out without additional fastening means 5 or screws 5, which can simplify assembly and save material costs.

A secure hold in the vertical direction Z or perpendicular to the horizontal X, Y can, if necessary, be achieved by forming the support element 6 and/or the spacer element 3 from an elastic material in order to exert a certain force from the inside or from below against the hook elements of the snap hooks 19 in the vertical direction Z or perpendicular to the horizontal X, Y. This can also compensate for manufacturing tolerances of these elements, components or structural parts in the vertical direction Z or perpendicular to the horizontal X, Y.

Simple and reliable positioning of the elements, components or structural parts of the planar-dynamic acoustic transducer 1 of the second embodiment example of FIG. 2 can be achieved by the oval design of the contour of the elements, components, or structural parts, which corresponds to the arrangement of the snap-in hooks 19 and can thus allow assembly as described above only in two mirror-symmetrical constellations. The elements, components, or structural parts of the planar-dynamic acoustic transducer 1 can be designed accordingly.

In addition, the upper ends of the snap hooks 19, which can be referred to as snap hook heads 19a or latching hook heads 19a, can be designed to be permanently magnetic towards the top, so that other elements, components or structural parts of the product in which the planar-dynamic acoustic transducer 1 is used or installed can be magnetically detachably connected to the planar-dynamic acoustic transducer 1 of the second embodiment example of FIG. 2. This can simplify the assembly of the product and/or create further possibilities for use.

In any case, the possibilities for electrical contacting of the conductor track 21 of the diaphragm film 2 described with regard to the first embodiment example of the planar-dynamic acoustic transducer 1 of FIG. 1 can also be used in the second embodiment example, in that the support element 6 now has a pair of contact elements 62 or contact surfaces 62 for conductor tracks 21 of the diaphragm film 2 and a pair of outer contact elements 63 or outer contact pins 63. This means that the corresponding electrical function can also be implemented and used in the second embodiment example as described above.

As an acoustic function, the magnet arrangement 1 or the magnet grid 1 can be designed with regard to the specific configuration and arrangement of the acoustic apertures 13 and the magnetic bars 12 or their magnetic poles in such a way that the sound field, the acoustic pressure, the sound velocity, or the sound flow in the environment of the planar-dynamic acoustic transducer 1 can be influenced, shaped on the basis of frequency or amplitude, or the vibration behavior of the diaphragm film 2 or other elements can be influenced in order to reduce or deliberately shape non-linear distortions or frequency-dependent amplitude fluctuations in the generated sound signal. For this purpose, the grid structure of the magnetic bars 12 of the magnet arrangement 1 can be designed for full acoustic transparency with regard to the degree of aperture and/or the shape of the acoustic openings 13. Alternatively, however, the acoustic apertures 13 of the magnet arrangement 1 can also have a defined acoustic resistance in order to realize damping of undesired vibration modes and non-linear distortions of the diaphragm 2. Alternatively, the acoustic apertures 13 of the magnet arrangement 1 may have regions that generate resonances and/or reflections, thereby amplifying or attenuating certain acoustic frequencies.

According to the illustrations in FIGS. 3 and 4, this can be implemented in concrete terms, for example, by introducing horizontal cavities 12a of the magnetic bars 12 along the inner region 11 and horizontal cavities 14a of the edge region 14 along the longitudinal direction X or parallel to the longitudinal direction X of the edge region 14 as the largest extension of the planar-dynamic acoustic transducer 1. Similarly, the horizontal cavities 12a of the magnetic bars 12 can also extend in the transverse direction Y. In any case, sound can enter the cavities through the horizontal cavities 12a of the magnetic bars 12 in the longitudinal direction X, through the horizontal cavities 12a of the magnetic bars 12 in the transverse direction Y and through the horizontal cavities 14a of the edge region 14 in the longitudinal direction X from the acoustic apertures 13 of the magnet arrangement into the cavities 12a, 14a, or vice versa. For this purpose, these cavities 12a, 14a are provided with apertures at selected positions through which sound flow can enter and exit.

In this manner, as an acoustic function of the magnet arrangement 1 and in particular its edge region 14 and/or interior 11, resonances and/or reflections can occur at certain acoustic frequencies whose wavelength is in a certain ratio to the respective cavity length and/or the respective opening distance, which are superimposed on the regular acoustic radiation of the planar-dynamic acoustic transducer 1. This superposition is constructive or destructive, depending on the phase position of the resonances and the spatial arrangement. This results in an amplification or attenuation of the sound emitted to the outside at these frequencies.

FIG. 5 is a perspective cross-sectional view of a magnet arrangement 1 of a planar-dynamic acoustic transducer 0 according to a fourth embodiment example from diagonally above. FIG. 5 is a perspective view of a magnet arrangement 1 whose edge region 14 has been formed into a baffle 10a, which largely prevents an acoustic short-circuit between the front and rear of the diaphragm in the relevant frequency range. Here, 11 denotes the inner region with a grid structure, formed by magnetic bars 12, which are materially connected to non-magnetic bars 12b.

FIG. 6 is a perspective cross-sectional view of a magnet arrangement 1 of a planar-dynamic acoustic transducer 0 according to a fifth embodiment example from diagonally below. FIG. 6 is a perspective view of a magnet arrangement 1 whose edge region 14 has been formed into a front housing shell that has a circumferential lateral wall 14b and bores 15, which can accommodate screws, for example, with the aid of which the front housing shell can be connected to a rear housing shell 7 in order to obtain a closed housing.

FIG. 7 is a perspective cross-sectional view of a magnet arrangement 1 of a planar-dynamic acoustic transducer 0 according to a sixth embodiment example from diagonally above. FIG. 7 is a perspective view of a magnet arrangement 1 whose edge region 14 has been formed into a front housing shell that has a circumferential side wall 14b and bores 15 that can, for example, accommodate screws, which can be used to connect the front housing wall or shell to a rear housing wall or shell (not shown) in order to obtain a closed housing. A further wall 14c, in conjunction with the rear housing wall not shown, forms an acoustic channel of defined length, which feeds sound energy from the rear of the membrane through a first aperture 14d to an acoustic outlet 14e, delaying it due to the sound propagation time and/or generating standing waves, whereby the radiated sound energy of the overall system can be influenced on the basis of the excitation frequency. Here, 14f denotes a raised contact surface for a diaphragm.

FIG. 8 is a perspective cross-sectional view of a magnet arrangement 1 of a planar-dynamic acoustic transducer 0 according to a seventh embodiment example from diagonally above. FIG. 8 is a perspective view of a magnet arrangement 1 whose edge region 14 has been formed into a front housing shell that has a circumferential side wall 14b and bores 15 that can, for example, accommodate screws, which can be used to connect the front housing wall or shell to a rear housing wall or shell (not shown) in order to obtain a closed housing. Two further walls 14c, in conjunction with the rear housing wall not shown, form an acoustic channel of defined length, which encloses an acoustic mass for a resonance system between a first aperture 14d and an acoustic outlet 14e.

FIG. 9 is a perspective cross-sectional view of a magnet arrangement 1 of a planar-dynamic acoustic transducer 0 according to an eighth embodiment example from diagonally above. FIG. 9 is a perspective view of a magnet arrangement 1 whose edge region 14 has been formed into a front housing shell that has a circumferential side wall 14b and bores 15 that can, for example, accommodate screws, which can be used to connect the front housing wall or shell to a rear housing wall or shell (not shown) in order to obtain a closed housing. The edge region 14 includes an additional inner region 11a that is smaller than the first inner region 11, as well as an additional raised contact surface 14h for an additional diaphragm. Due to its reduced dimensions, the additional acoustic transducer to be formed in this manner is better suited for reproducing higher acoustic frequencies than the acoustic transducer formed by the first inner region 11 and the diaphragm support 14f and the associated first diaphragm.

FIG. 10 is a perspective cross-sectional view of a magnet arrangement 1 of a planar-dynamic acoustic transducer 0 according to a ninth embodiment example from diagonally above. FIG. 10 shows the magnet arrangement 1 from FIG. 9, which, in conjunction with a rear housing wall not shown, forms a housing with an enclosed air volume. Said housing is divided by the additional wall 14i into two separate air volumes, which are assigned to the first inner region 11 and the additional inner region 11a respectively.

FIG. 11 is a perspective cross-sectional view of a magnet arrangement 1 of a planar-dynamic acoustic transducer 0 according to a tenth embodiment example from diagonally above. Here, the inner region 11 is formed from several material components processed in the same manufacturing process, such as an injection molding process. In particular, the magnetic bars 12 are embodiment in the Z direction only as strong as is necessary to provide a one-sided multipole magnetic field. The magnetic bars 12 are mechanically supported or carried by further bars 12b made of non-magnetic material, which are approximately congruent in the horizontal and adjacent in the vertical.

FIG. 12 is a perspective cross-sectional view of a magnet arrangement 1 of a planar-dynamic acoustic transducer 0 according to an eleventh embodiment example from diagonally above. 14 denotes the edge region, which also provides a raised contact surface 14f for a diaphragm. 11 denotes the inner region with grid structure, wherein outer apertures or slots 13a have a smaller width than inner apertures or slots 13b in order to concentrate the acoustic radiation on the inner apertures and convert the area sound source approximately into a line or point sound source.

FIG. 13 is a perspective cross-sectional view of a magnet arrangement 1 of a planar-dynamic acoustic transducer 0 according to a twelfth embodiment example from diagonally above. FIG. 14 shows FIG. 13 from below. FIG. 13 (top side) and FIG. 14 (bottom side) show the magnet arrangement 1 of FIG. 9, with a different shape of the acoustic channel, which is formed by the lateral wall 14b and the further wall 14c. The edge region 14 continues outside the lateral wall 14b and thus merges seamlessly into a surface 14g, which is part of a larger structure and is only shown here in simplified form as a circular, flat disk. However, it can be shaped in almost any manner and can, for example, form the rear wall of a screen housing or a luminaire, an outer surface of a piece of furniture or a ceiling suspension, or a trim surface of a door, roof, dashboard, parcel shelf, footwell, or seat of a vehicle. Further lining, e.g. by attaching foils, lining materials or upholstery foam, is unaffected, but should be embodied in an acoustically transparent manner in the region of the sound outlets. This integration into a continuous larger structure makes it necessary for the acoustic outlet 14e to lie substantially in the plane of the inner region 11 and thus emit sound to the outside on the same side as the acoustic transducer. This applies accordingly when using a delay channel, as shown in FIG. 9.

### List of Reference Signs (Part of the Description)

X longitudinal direction; depth; length
Y transverse direction; width
Z vertical direction; height
X, Y horizontal, horizontal plane
0 planar-dynamic acoustic transducer
1 magnet arrangement; magnet grid; magnet system
10 magnet body
10a baffle
11 inner region; depression
11a additional inner region
12 magnetic bars
12a (horizontal) cavities of the inner region 11 or the magnetic bars 12
12 non-magnetic bars
13 acoustic apertures of magnet arrangement 1
13a acoustic apertures of smaller width of magnet arrangement 1
13b acoustic apertures of bigger width of magnet arrangement 1
14 edge region
14a (horizontal) cavities of the edge region 14
14b lateral wall of the edge region 14
14c further wall (acoustic channel) of the edge region 14
14d first aperture (acoustic channel) of the edge region 14
14e acoustic outlet (acoustic channel) of the edge region 14
14f increased contact surface for diaphragm of edge region 14
14g surface (part of larger structure) of the edge region 14
14h additional raised contact surface for additional diaphragm of the edge region 14
14i additional wall (separation of air volumes) of the edge region 14
15 receptacles for fastening means 5; bores with internal thread
16 guide tenon; guide pins
17 contact elements or contact surfaces for conductor tracks 21 of diaphragm 2
18 outer contact elements or outer contact pins
19 snap hook; snap-in hook
19a snap hook head; snap-in hook head
2 diaphragm; diaphragm film
20 diaphragm body
21 conductor track
21a longitudinal portions of conductor track 21
21b sweeps of the conductor track 21
21c conductor track ends; contact points of the conductor track 21
22 through-openings for fastening means 5
23 through-openings for guide tenons 16 of magnet arrangement 1
3 spacer element; first ring
30 spacer element body
31 hollow inner region
32 through-openings for fastening means 5
33 through-openings for guide tenons 16 of magnet arrangement 1
4 protective grid
40 protective grid body
41 acoustic apertures of the protective grid 4
42 through-openings for fastening means 5
43 through-openings for guide tenons 16 of magnet arrangement 1
5 fastening materials; screws
6 support element; receiving element; second ring
60 support element body
61 hollow inner region
62 contact elements or contact surfaces for conductor tracks 21 of diaphragm 2
63 outer contact elements or outer contact pins
7 rear housing shell

1. A planar-dynamic acoustic transducer comprising:
at least one magnet arrangement having a plurality of magnetic poles and having at least one acoustic aperture; and
a diaphragm having at least one conductor track,
wherein the magnet arrangement has an inner region, which includes the magnetic poles, and an edge region, which surrounds the inner region and connects the elements thereof to one another,
wherein the inner region of the magnet arrangement is arranged in a manner offset from the conductor track of the diaphragm perpendicular to the horizontal and in a manner at least overlapping, with the conductor track of the diaphragm in the horizontal,
characterized in that
the edge region of the magnet arrangement furthermore includes at least one mechanical, acoustic and/or electrical function of the planar-dynamic acoustic transducer.

2. The planar-dynamic acoustic transducer according to claim 1,
wherein the inner region of the magnet arrangement and the edge region of the magnet arrangement are formed in one piece by a magnet body, and
wherein at least the inner region of the magnet arrangement comprises a hard-magnetic material.

3. The planar-dynamic acoustic transducer according to claim 1,
wherein the edge region of the magnet arrangement is formed from a different material than the inner region of the magnet arrangement, preferably from a material with a lower specific weight and/or from a material with a lower or no magnetization and/or from an elastic material.

4. The planar-dynamic acoustic transducer according to claim 1,
wherein the inner region of the magnet arrangement was formed from a first material in a first method step and the edge region of the magnet arrangement was subsequently formed from a second, different material in a second method step.

5. The planar-dynamic acoustic transducer according to claim 1,
wherein the edge region, preferably and portions of the inner region, of the magnet arrangement was formed from a first material in a first method step and the inner region of the magnet arrangement was subsequently formed from a second, different material in a second method step.

6. The planar-dynamic acoustic transducer according to claim 1,
wherein the edge region includes an elastic material at least in portions, preferably formed in a third method step in portions from a third, different elastic material.

7. The planar-dynamic acoustic transducer according to any claim 1,
wherein the edge region of the magnet arrangement perpendicular to the horizontal is higher than the inner region of the magnet arrangement,
wherein the diaphragm is in direct contact with the edge region of the magnet arrangement.

8. (canceled)

9. The planar-dynamic acoustic transducer according to claim 1,
further comprising at least one support element, which is arranged perpendicular to the horizontal between the edge region of the magnet arrangement and the diaphragm and distances the inner region of the magnet arrangement from the diaphragm by means of a hollow inner region.

10-12. (canceled)

13. The planar-dynamic acoustic transducer according to claim 1,
wherein the edge region of the magnet arrangement has at least one guide tenon, preferably a pair of guide tenons, and the diaphragm, preferably and a support element and/or a spacer element and/or a protective grid, has at least one through-opening, preferably a pair of through-openings, for the guide tenon of the magnet arrangement.

14. The planar-dynamic acoustic transducer according to claim 1,
wherein the edge region of the magnet arrangement has at least one receptacle, preferably a plurality of receptacles, for receiving a fastening means, preferably a screw, and
wherein the diaphragm, preferably and a support element and/or a spacer element and/or a protective grid, has at least one through-opening, preferably a plurality of through-openings, for the fastening means.

15. The planar-dynamic acoustic transducer according to claim 1,
wherein the edge region of the magnet arrangement has at least one snap hook, preferably a plurality of snap hooks, for engaging around the diaphragm, preferably or a spacer element or a protective grid,
wherein preferably a snap hook head facing away from the magnet arrangement is magnetically formed.

16. The planar-dynamic acoustic transducer according to claim 1,
wherein the edge region has at least one, preferably horizontal, cavity, preferably several, preferably horizontal, cavities, which is open, preferably to at least one acoustic aperture, particularly preferably to several acoustic apertures,
wherein the length of the cavity and/or the distance between two apertures of the cavity is selected such that at least one acoustic frequency whose wavelength is in a predetermined ratio to the length of the cavity and/or to the distance between two apertures of the cavity undergoes resonance and/or reflection.

17. The planar-dynamic acoustic transducer according to claim 1,
wherein the inner region, preferably at least one magnetic web, more preferably several magnetic webs, most preferably all magnetic webs, of the inner region has at least one, preferably horizontal, cavity, preferably several, preferably horizontal, cavities, which is open, preferably to at least one acoustic aperture, more preferably to several acoustic apertures,
wherein the length of the cavity and/or the distance between two apertures of the cavity is selected such that at least one acoustic frequency whose wavelength is in a predetermined ratio to the length of the cavity and/or to the distance between two apertures of the cavity undergoes resonance and/or reflection.

18. The planar-dynamic acoustic transducer according to claim 1,
wherein the inner region is acoustically more transparent in portions, in particular for high acoustic frequencies, and otherwise acoustically less transparent, in particular for high acoustic frequencies.

19. The planar-dynamic acoustic transducer according to claim 1,
further comprising a mirror-symmetrical pair of magnet arrangements surrounding the diaphragm perpendicular to the horizontal.

20. The planar-dynamic acoustic transducer according to claim 1,
wherein the magnet arrangement has at least one further inner region, which has magnetic poles and is surrounded by the edge region.

21-22. (canceled)

23. The planar-dynamic acoustic transducer according to claim 1,
wherein the edge region of the magnet arrangement is formed as a baffle.

24. The planar-dynamic acoustic transducer according to claim 1, wherein the edge region of the magnet arrangement has at least one wall which extends substantially outside the horizontal and which encloses at least one inner region at least in portions.

25. (canceled)

26. The planar-dynamic acoustic transducer according to claim 1,
wherein the edge region of the magnet arrangement has at least one wall that extends substantially outside the horizontal and forms at least one acoustic channel, which is designed to communicate acoustically with the air volume above the inner region and with the surrounding atmosphere.

27-32. (canceled)
